(19) United States
(12) Patent Application Publication
(10) Pub. No.: US 2025/0377336 A1
(43) Pub. Date: Dec. 11, 2025

(54) COATING INNER SURFACES OF ENCLOSED ARTICLES

(71) Applicant: University of Tasmania, Sandy Bay, Tasmania (AU)

(72) Inventors: Michael Charles Breadmore, Sandy Bay, Tasmania (AU); Vipul Gupta, Sandy Bay, Tasmania (AU); Mostafa Adel Atia Abuzeid, Sandy Bay, Tasmania (AU); Petr Smejkal, Sandy Bay, Tasmania (AU)

(21) Appl. No.: 18/877,861

(22) PCT Filed: Jun. 20, 2023
(86) PCT No.: PCT/AU2023/050553

§ 371 Date: Dec. 20, 2024

(30) Foreign Application Priority Data
Jun. 20, 2022 (AU) 2022901678

(51) Int. Cl. G01N 27/447; B01J 20/26; B01J 20/32; B01L 3/00; C08F 2/34

(52) U.S. Cl. CPC G01N 27/44791; B01J 20/264; B01J 20/3204; B01J 20/3219; B01J 20/3272; B01L 3/502707; B01L 3/502715; B01L 3/502738; C08F 2/34

(57) ABSTRACT

The present disclosure relates to a method for the production of an inner surface coating on an enclosed article, such as a capillary. the method comprising vaporizing a first monomer and reacting the vaporized first monomer with the inner surface of an enclosed article to provide a monomer layer on the inner surface of the enclosed article. Also disclosed are coated enclosed articles and apparatus for performing the method.

### RELATED APPLICATIONS

This application claims the benefit of Australian Provisional Patent Application No 2022901678, filed on 20 Jun. 2022, which is incorporated herein by reference in its entirety.

### TECHNICAL FIELD

The present invention relates to methods for coating inner surfaces of enclosed articles, products produced by the methods and apparatus for performing the methods. The enclosed article may especially be a capillary which is suitable for use as the capillary in capillary electrophoresis and other capillary separation techniques.

### BACKGROUND ART

Capillary electrophoresis (CE) is an analytical technique that is used to separate ions based on their electrophoretic mobility within a capillary under the application of a voltage potential. One of the major drawbacks of the use of capillary electrophoresis (CE) is the poor repeatability and reproducibility when compared with other analytical techniques because of the variability in electro-osmotic flow, especially when a normal fused silica capillary is used. One approach to solve this problem is using capillaries internally coated with different materials to change the surface character. This is usually done by flushing a capillary with different liquid coating materials. However, liquid coating methods encounter various limitations including the generation of high back-pressure and concentration gradients along the capillary length, low coating consistency and low reproducibility, especially when applied to long narrow diameter capillaries.

The most common coatings applied to fused silica capillaries by liquid flushing are based on silanes, since silanes provide a durable interface between inorganic substrates and organic coatings. However, silanes are often highly prone to degradation and/or self-polymerization in the presence of moisture and often rely on toxic and unstable compounds. Moreover, silanes alone usually fail to suppress the electro-osmotic flow effectively, since they result in a thin surface coating that results in residual surface-exposed silanol groups.

A more effective electro-osmotic flow suppression can be obtained by applying a thicker surface coating using polymeric coatings instead of monolayer silane coatings. This is conventionally achieved by flushing a silanized capillary with a ready-made polymer in a solution. However, such solutions of ready-made polymers tend to have high viscosity, further aggravating the above-mentioned limitations of liquid coatings. Furthermore, there is often rapid degradation of the capillary surface in use during capillary electrophoresis because the polymeric layer is mostly physiosorbed on the capillary surface, rather than chemically bonded thereto. This results in deteriorating quality of analytical results, and the need to re-apply the coating or replace the capillary with a new coated capillary, which due to low coating reproducibility is at times not consistent with the original capillary and may cast doubt on analytical results obtained.

The above is generally true of the coating of inner surfaces of other enclosed articles. Coating is usually done by flushing with different liquid coating materials with one or more of the same associated problems.

It would be beneficial to provide new methods for the production of internally coated surfaces of enclosed articles, especially capillaries. It would also be beneficial to provide coated capillaries and other enclosed articles with more consistent and controllable inner surface coatings.

### SUMMARY

In one aspect, the present application provides a method for the production of an inner surface coating on an enclosed article, such as a capillary, the method comprising vaporizing a first monomer and reacting the vaporized first monomer with the inner surface of an enclosed article to provide a first monomer layer on the inner surface of the enclosed article.

This may be followed by a second vaporization and reaction step, comprising vaporizing a second monomer and reacting the vaporized second monomer with the first monomer on the inner surface of the enclosed article to provide a second monomer layer on the inner surface of the enclosed article.

Accordingly, in another aspect, the present application provides a method for the production of an inner surface coating on an enclosed article, such as a capillary, the method comprising:
vaporizing a first monomer and reacting the vaporized first monomer with an inner surface of an enclosed article to provide a first monomer layer on the inner surface of the enclosed article, and
vaporizing a second monomer and reacting the vaporized second monomer with the first monomer on the inner surface of the enclosed article to provide a second monomer layer on the inner surface of the enclosed article.

The application of a first monomer and a second monomer (and subsequent monomers) in separate alternating stages in the method allows for the formation of a controlled coating on the inner surface of the enclosed article. Initially, a dimer coating may be applied through the separate, sequential application of a first and then a second monomer. By being applied separately and sequentially, a first monomer is applied in isolation; that is, in the absence of a second monomer. Then in a subsequent step, a second monomer is applied in isolation, to form a dimer with the first applied monomer. Thereafter, the dimer coating can be extended by the application of a third, fourth, fifth etc. monomer in separate alternating stages for the formation of a controlled oligomeric or polymeric coating on the inner surface of the enclosed article. For example, the coating steps with first and second monomers can be repeated in an alternating sequence of first monomer reaction followed by second monomer reaction, to form an oligomeric or alternating co-polymer coating on the inner surface of the enclosed article in a controlled manner. It may also be possible to then change the identity of the monomers being applied, to then change from the one polymer type to another polymeric type, through the alternating application of third and fourth monomers etc. by the same technique.

The controlled formation of a coating on the inner surface is very important, especially in the context of capillaries used for capillary electrophoresis in analytical processes. This is because there is the risk of capillary blockage with prior art processes, which is avoided with the method of the present application. Prior art processes also suffer from the high back-pressure of the liquids being delivered into the capillary due to the viscosity of the coating composition liquids, concentration gradients along the capillary length, low coating consistency and low reproducibility.

In contrast to prior art methods, the present method involves the vaporization of the monomers to be applied to the inner surface of the enclosed article. This allows for concentration gradients to be reduced or avoided and for increased coating consistency. Using separate and sequential monomer applications, this further allows for the controlled formation of monomeric coating layers in sequence on the inner surface of the enclosed article, yielding a controlled surface composition with controlled e.g. oligomer or polymer length. Further, the surface composition may be applied in what may be viewed as two half-reactions, through the application of a first monomer species then the separate application of a second monomer species. The process of applying each monomer individually including in two half-reaction may be viewed as a form of molecular layer deposition (MLD). This is in contrast to processes involving the channeling of all, or at least more than one, reactive species together through an enclosed article for the formation of a polymeric surface with an uncontrolled molecular weight and variation along the surface of the enclosed article, as is typically done using liquid coating methods.

While coating of the inner surface of the enclosed article in the vapor phase provides the advantages of improved flow, it was nevertheless unexpected that, especially in the case of a capillary with a small available volume for transmission of reagents compared to the surface area, a good quality coating can be applied along the length of the enclosed article (such as a capillary). Prior art processes for gas-phase application of coatings to open surfaces have the advantage of a large gaseous volume surrounding the surface to be coated to allow for high reagent volumes to be directed to the surface, and fast removal of the reaction byproducts. A low gas-space volume to surface area ratio such as may be found with an enclosed article provides a challenge for the application of the coating, but for the first time, the applicant has achieved and demonstrated the production of an effective, controlled coating layer along the inner surface of an enclosed article including narrow gauge capillaries of significant length.

In preferred embodiments, each of the vaporization and reaction steps is performed under the application of a pressure differential. Preferably, the steps are performed under the application of a negative pressure (vacuum). In the case of a preferred enclosed article having two openings, the negative pressure is preferably applied at one end of the enclosed article (e.g. capillary) opposite to an inlet end of the enclosed article through which the vaporized reagents enter the enclosed article. A negative pressure is advantageous as a means for drawing the vaporized monomer reagents into the enclosed articles (e.g. capillaries). This also permits vaporization of the monomer reagents to be achieved under reduced temperatures as compared to the vaporization temperatures at atmospheric pressure. As noted above, the reaction of the monomer with the inner surface of the enclosed article (e.g. capillary) may generate byproducts that are suitably flushed away from the inner surface. The vacuum further aids in the effective flushing of the reaction byproducts, and any unreacted or physiosorbed monomers, away from the inner surface of the enclosed article.

The method involves the reaction of a first monomer with an inner surface of an enclosed article. The method may further comprise a preliminary step in which an anchor layer is formed on the native inner surface of the enclosed article (such as a capillary). Thus, in some embodiments, the method further comprises:
vaporizing an anchor layer composition and reacting the vaporized anchor layer composition with a native inner surface of an enclosed article to provide an anchor layer on the inner surface of the enclosed article.

In this context, it will be understood that the anchor layer composition is different to the first, second or any subsequent monomer. The anchor layer may similarly be applied in a discreet step, applied separately and in isolation.

The anchor layer provides an exposed anchor layer functional group on the inner surface of the enclosed article. This anchor layer functional group is available for reaction with the first monomer subsequently brought into contact with the inner surface of the enclosed article.

The step of forming the anchor layer is suitably performed by chemical vapor deposition (CVD).

The application of the anchor coating layer (e.g. by CVD) is preferably performed under vacuum, as for the application of the monomers. Using vacuum to coat the inner surface of enclosed articles with anchor compositions decreases the required reaction temperature. The application of the anchor coating layer in the manner specified results in a more homogenous monolayer coating of the anchor layer as compared to flushing with a liquid formulation. The anchor layer can be in angstrom to nanometer thickness to prevent capillary blockage during coating.

In preferred embodiments, the anchor layer composition comprises a silane. That is, the anchor layer composition may comprise a silane coupling agent. A silane is preferred to provide a durable and chemically bonded coating, especially in the case of coating to a fused silica enclosed article. The use of CVD at reduced temperature to coat silanes to inner surfaces of enclosed articles confers the advantage of minimizing or eliminating the water effect, being the propensity for silanes to degrade and/or self-polymerise in the presence of liquid water.

In preferred embodiments, the enclosed article comprises a silica; that is, is at least in part made up of a silica material. Thus, the enclosed article may be a siliceous enclosed article. As one example, the enclosed article may be a fused silica capillary. Fused silica capillaries typically comprise a fused silica inner layer and a polymeric exterior coating.

Suitable monomers for use as the first, second and subsequent monomers are set out below in the detailed description but generally correspond to the formation of polymers, and especially in the case of MLD using half-reactions, alternating copolymers such as Kevlar.

With this approach, several layers can be applied inside a narrow diameter silica capillary by vapor phase polymer growth inside the capillary that will modify the capillary inner surface character and shield the effect of any residual silanol groups present on the inner surface leading to the modification of the EOF.

In another aspect, the present application provides a coated capillary formed by the method as described herein.

In another aspect, the present application provides a coated capillary, the capillary comprising a polymeric inner surface coating with a uniform, controlled polymer chain length. The coated capillary is obtainable by the method outlined above.

In another aspect, the present invention provides an apparatus for forming an inner surface coating on an enclosed article (such as a capillary), the apparatus comprising:
a heating chamber
a reagent vessel
connectors for fluid connection of the enclosed article with the reagent vessel and a vacuum pump so that the enclosed article will be positioned within the heating chamber and in fluid connection with the regent vessel and a vacuum pump when connected;
whereby, in operation, a reagent can be vaporized in the reagent vessel under vacuum and/or upon the application of heat, and the vaporized reagent can pass into the enclosed article for reaction with the inner surface of the enclosed article for the formation of a coating of the inner surface of the enclosed article.

The apparatus may further comprise a condenser for condensing any condensable gases that emerge from the enclosed article, preferably positioned externally to the heating chamber and upstream of any connected vacuum pump. The apparatus may also comprise a valve for controlling the vapor flow into the enclosed article. The valve may also allow the enclosed article to be disconnected from the reagent vessel, to allow a second regent to be placed in the reagent vessel for vaporization and passage into the enclosed article. The apparatus may also comprise a vacuum pump, preferably positioned externally to the heating chamber and down-stream of any condenser. The apparatus may also comprise a connector for connecting an inert gas source in fluid connection with the enclosed article, and an inert gas source. The connection of the inert gas source may be made via a valve for controlling the inert gas flow into the enclosed article, which may be different or the same as the valve for controlling the reagent flow.

### DESCRIPTION OF THE FIGURES

FIG. 1 shows an apparatus used to coat the inner surface of an enclosed article, in this case a capillary, using CVD. FIG. 1A is a manual apparatus; FIG. 1B is an automated apparatus.

FIG. 2 plots the EOF at different pHs for capillaries individually internally coated with PFOCTS, GPTMS, APTMS and MPTMS using CVD, as compared to an uncoated fused silica capillary.

FIG. 3 plots the EOF measured at different pHs for a capillary coated to GPTMS using CVD as compared to using liquid phase deposition.

FIG. 4 plots the conductivity measured across a capillary coated with GPTMS by CVD, as compared with an uncoated fused silica capillary, measured using a C4D detector after filling the capillaries with 9.5 mM Tris/230 mM Citrate at pH 9 flowing at 1 μL/min using a syringe pump.

FIG. 5 plots the EOF measured at different pHs for capillaries coated with APTMS using CVD then end-capped using MTS or PTS, as compared with a capillary coated with only APTMS using CVD.

FIG. 6 plots the EOF measured at different pHs for capillaries coated with GPTMS using CVD and then further treated with H₂SO₄ gas or NH₃ gas using CVD, as compared to a capillary coated with only GPTMS using CVD.

FIG. 7(A) plots the EOF measured at different pHs for capillaries coated with a) GPTMS and PD and b) and GPTMS, PD and TA, using CVD and MLD, as compared to capillaries coated with c) GPTMS and d) GPTMS then farther treated with NH₃ gas, using CVD.

FIG. 7(B) plots the EOF measured at different pHs for capillaries coated with b) GPTMS then further treated with PD then TA and c) GPTMS, PD, TA, PD and TA, using CVD and MLD, as compared to a capillary coated with a) GPTMS.

FIG. 8(A) plots the long-term stability of the coating represented by monitoring the apparent mobility of Cl⁻, NO₂, ⁻NO₃⁻, SO₄⁻² in water.

FIG. 8(B) plots the normalized mobility of Cl⁻, NO₃⁻, SO₄⁻² when NO₂⁻ used as internal standard for 35 days.

FIG. 9 plots the separation of a) epinephrine b) lidocaine c) bupavacaine and d) dubutamine from degradation product of Epinephrine (*) using capillary electrophoresis using a capillary coated with GPTMS using CVD.

FIG. 10 plots the separation of methamphetamine, pseudoephedrine and arginine using capillary electrophoresis using a capillary coated with GPTMS using CVD.

FIG. 11(A) plots the EOF measured at different pHs for capillaries coated with 1, 2, 5, 10, 25 and 50 layers of a PD-TA unit, being 2, 4, 10, 20, 50 and 100 layers of individually applied PD and TA monomers, terminated with PD, as compared to capillaries coated with GPTMS.

FIG. 11(B) shows the influence of adding 1, 2, 5, 10, 25 and 50 layers of a PD-TA unit, being 2, 4, 10, 20, 50 and 100 layers of individually applied PD and TA monomers, terminated with PD, measured at pH 3 and 9.

FIG. 12(A) plots the EOF measured at different pHs for capillaries coated with 1, 2, 5, 10, 25 and 50 layers of a PD-TA unit, being 2, 4, 10, 20, 50 and 100 layers of individually applied PD and TA monomers, terminated with TA, as compared to capillaries coated with GPTMS.

FIG. 12 (B) shows the influence of adding 1, 2, 5, 10, 25 and 50 layers of a PD-TA unit, being 2, 4, 10, 20, 50 and 100 layers of individually applied PD and TA monomers, terminated with TA, measured at pH 3 and 9.

### DETAILED DESCRIPTION

Unless defined otherwise, all technical and scientific terms used herein have the same meaning as commonly understood by those of ordinary skill in the art of the invention. Although any methods and materials similar or equivalent to those described herein can be used in the practice or testing of the present invention, preferred methods and materials are described. For the purposes of the present invention, a number of terms are defined throughout.

As outlined above, in broad terms, the present application provides a method for the production of an inner surface coating on an enclosed article, such as a capillary, the method comprising a first vaporizing step of a first monomer in isolation—that is, in the absence of a second or further monomer—and reacting the first monomer with the inner surface of the enclosed article to provide a monomer layer on the inner surface of the enclosed article. Where there is an anchor layer comprising exposed anchor layer functional groups on the inner surface, then the reaction of the first monomer is with the anchor layer functional groups. This may be followed by a second vaporization step of a second monomer in isolation—that is, in the absence of another monomer—and reacting the second monomer with the first monomer to provide a second monomer layer on the inner surface of the enclosed article. This may be followed by separate third and subsequent vaporization and monomer coating steps. The application of two monomers separately which may be said to be applied in half-reactions may also be viewed as a specific form of molecular layer deposition (MLD). There may also be a preliminary step of vaporizing an anchor layer composition and reacting the vaporized anchor layer composition with a native inner surface of an enclosed article to form an anchor layer on the inner surface of the enclosed article. This preliminary step may be viewed as a form of CVD. It is to be noted that CVD and MLD are related, but in MLD two different monomers are applied separately and individually in a two-step process involving two half-reactions (and repetition where desired) to generate the complete chemical component, whereas CVD is a term that is more commonly used to refer to the application of a pre-prepared complete chemical composition onto a surface. The application of the anchor layer by a similar sequence of vaporizing and gas flow steps is not an essential feature of the invention, but it will commonly be performed prior to the application, or MLD, of the monomers. In the following description, the application of the anchor layer composition followed by the application of the monomers in this sequence is described.

In combination, the method for the production of an inner surface coating on the enclosed article (e.g. capillary) in some embodiments comprises:
a) vaporizing an anchor layer composition and reacting the vaporized anchor layer composition with an inner surface of an enclosed article to provide an anchor layer on the inner surface of the enclosed article;
b) vaporizing a first monomer and reacting the vaporized first monomer with the anchor layer on the inner surface of the enclosed article, to provide a first monomer layer on the inner surface of the enclosed article, and
c) vaporizing a second monomer and reacting the vaporized second monomer with the first monomer on the inner surface of the enclosed article to provide a second monomer layer on the inner surface of the enclosed article.

The inner surface of the enclosed article may be described as a native inner surface. The native inner surface of the enclosed article, the anchor layer compositions and the monomers are chemical species. As used herein, reactions of chemical species are taken to occur between chemical functional groups to form covalent bonds between them and connecting functional groups. That is, the reactions between the anchor layer and the native inner surface of the enclosed article, the first monomer and the native inner surface of the enclosed article, the first monomer and the anchor layer, the second monomer and the first monomer etc., whatever the case may be, occurs between chemical functional groups of the reacting species to connect them together. Specifically:
a reaction between the anchor layer composition and the native inner surface of the enclosed article occurs between an exposed functional group of the native inner surface and a reactive functional group of the anchor layer composition (i.e. the chemical species in the anchor layer composition);
a reaction between the first monomer and the native inner surface of the enclosed article occurs between an exposed functional group of the native inner surface and a reactive functional group of the first monomer;
a reaction between the first monomer and the anchor layer on the inner surface of the enclosed article occurs between an exposed functional group of the anchor layer and a reactive functional group of the first monomer;
a reaction between the second monomer and the first monomer layer on the inner surface of the enclosed article occurs between an exposed functional group of the first monomer and a reactive functional group of the second monomer;
and so on.

That is, a chemical species in the methods of the present application may undergo two reactions and as such has two important functional groups: a reactive functional group for attaching to the surface, and an exposed functional group to which further surface attachment may be made. For example, an anchor layer composition which reacts with the native inner surface of the enclosed article and also reacts with the first monomer, has a reactive functional group for attaching to the surface, and an exposed functional group to which further surface attachment of the first monomer may be made.

Accordingly, the present application as outlined above in its broad terms may also be considered in the following terms: to comprise a first vaporizing step of a first monomer having a reactive functional group, and reacting the reactive functional group of the vaporized monomer with an exposed functional group on the inner surface of the enclosed article, to form a connecting functional group between them to provide a monomer layer on the inner surface of the enclosed article, and optionally to provide an exposed functional group of the first monomer on the inner surface for reacting with a reactive functional group of a second monomer.

When an anchor layer is applied in a preliminary step, the preliminary step may similarly be considered in the following terms: to comprise vaporizing an anchor layer composition having a reactive functional group, and reacting the reactive functional group of the vaporized anchor layer composition with an exposed functional group on the native inner surface of the enclosed article, to form a connecting functional group between them to provide an anchor layer on the inner surface of the enclosed article, and to provide an exposed functional group of the anchor layer on the inner surface for reacting with a reactive functional group of a first monomer.

The same applies to second and subsequent monomers when the preceding monomer provides an exposed functional group on the inner surface.

That is, in the present invention, the application of monomers—the application of a first monomer to a surface and the oligomerization or polymerization of monomers in sequential steps—is intended to occur as an interlayer reaction of separate monomers to form discreet monomer layers. The application of a first monomer to a surface and the oligomerization or polymerization of monomers is intended to be free of intralayer reactions, being reactions between monomers for or within the same layer or during a single step. Each monomer layer is therefore intended to consist of a single monomer (i.e. its reaction product coated to the inner surface). In other words, a monomer is not self-reacting.

Accordingly, each monomer may be said to be applied individually or in isolation and to form a monolayer, meaning that each monomer consists of a single chemical species that is not self-reacting; a monomer is not a mixture comprising two or more chemical species which react with the inner surface of the enclosed article in the formation of a layer, and is capable of forming only one monomer layer chemical species under the conditions used. Similarly, each monomer layer may be said to be a monolayer, consisting of a single monomer—of the reaction product of a single monomer with the inner surface of the enclosed article. A single monomer layer is not made up of a layered mixture of two or more monomers; it is made up of only one monomer layer chemical species under the conditions used.

The reactions described herein may be assisted by a facilitator such an added energy source (e.g. light) or additional reagent (e.g. catalyst, base, acid, initiator or other). Such assisted chemical reactions are known or determinable by those skilled in the art. Examples include reaction types as commonly used in CVD methods which are catalyzed by ammonia, water, alcohols, hydrogen peroxide and metals, primarily nickel and iron metal catalysts. For clarity, the application of heat, vacuum (negative pressure), positive pressure and/or a carrier which would constitute the conditions used to perform CVD or MLD, does not constitute facilitation. In preferred embodiments, the reactions are unassisted, meaning that they will occur without the addition of a facilitator. Unassisted chemical reactions are known or determinable by those skilled in the art. Many unassisted chemical reactions fall into the categories of condensation reactions (including dehydration), addition reactions (including cycloaddition) and substitution reactions. Functional groups which may participate in unassisted reactions with other functional groups are known or determinable by those skilled in the art and many are described below.

Expressed in alternative terms, the method for the production of an inner surface coating on the enclosed article (e.g. capillary) in some embodiments comprises:
a) vaporizing an anchor layer composition and reacting the vaporized anchor layer composition with an exposed functional group on the native inner surface of an enclosed article to provide an anchor layer on the inner surface of the enclosed article with an exposed anchor layer functional group;
b) vaporizing a first monomer and reacting the vaporized first monomer with the exposed anchor layer functional group on the inner surface of the enclosed article, to yield an exposed first functional group of the first monomer on the inner surface of the enclosed article, and
c) vaporizing a second monomer and reacting the vaporized second monomer with the exposed first functional group of the first monomer within the enclosed article.

### Enclosed Articles Capillaries

The term “enclosed article” refers to articles with at least one opening and an enclosed space in connection with the opening(s) and bounded by in inner surface wall. Examples of such enclosed articles include tubular articles, tubes, ducts, flues, vents, pipes, columns and capillaries. The expression also encompasses microchannels (channels with an internal diameter of 500 μm or less, preferably 100 μm or less, more preferably 50 μm or less and most preferably 25 μm or less) in microchips. Capillaries are commonly used in capillary electrophoresis and other chemical processes and the term “capillary” is used herein in the same sense as it is understood in the art. Capillaries are typically characterized by small internal diameters. They may also have a high length to internal-diameter ratio. Typical capillary internal diameters may be up to 500 μm. The present application is suitable for the application of a consistent inner coating on a capillary of even smaller internal diameters, including capillaries with internal diameters of up to 400 μm, 300 μm, 200 μm, 100 μm, 90 μm, 80 μm, 70 μm, 60 μm, 50 μm, 25 μm, 10 μm or even less. Coating is achievable on capillaries with an internal diameter as low as 5 μm, 10 μm, 1 μm or even 0.1 μm. While the process for inner surface coating is particularly applicable and advantageous for coating capillaries, the concepts may be applied to other enclosed articles such as those described above, particularly those of a type used in chemistry, such as columns for use in chromatography. While herein reference is made to “capillary” coating, it will be understood that the description can be applied equally to other forms of enclosed articles.

The enclosed articles may have any suitable length. The length may be up to 500 meters long, for example. In the case of wider internal-diameter elongate articles (e.g. tubes, ducts, pipes), a short length may be better suited in view of the application of a reduced pressure (vacuum) to the interior of the enclosed article during the vaporization and transmission of the vaporized reagents into the enclosed article. However, for lower internal-diameter elongate articles, such as columns and capillaries in particular, the length may be much greater. Elongate articles such as capillaries of up to 500 meters in length may be coated by the present method. The length may be up to 400 m, 300 m, 200 m, 100 m, 50 m, 40 m, 20 m, 10 m or otherwise. The length will typically be at least 10 cm, at least 20 cm, at least 50 cm, at least 1 m, at least 1.5 m, at least 2 m, at least 3 m, at least 4 m or at least 5 m. In the test work the capillary length was typically about 5 meters. The ability to coat relatively long articles, with low internal diameter, along their length is difficult using known coating processes. The ability to coat capillaries and other elongate enclosed articles with a minimum length of 0.5 m, 1 m, 1.5 m, 2 m or even longer is a notable achievement. Once coated, long articles may be cut into several shorter coated articles for use as required.

The enclosed articles, or capillaries, typically have a low internal volume compared to the surface area being coated. This presents challenges with prior art processes for coating such articles. The volume to surface area ratio of a capillary can be calculated by a simple formula. For the purposes of assessing or calculating a volume to surface area ratio for comparison to the values described herein, any surface irregularities are ignored—and calculations are made by reference to the conversion of the internal diameter (i.d.) into a wall surface area. The volume is calculated as π(i.d./2)²l, where i.d. refers to the internal diameter and l is the length of the capillary. The surface area is calculated as π(i.d.)l, where i.d. and l are as defined above. In calculating the ratio of the two, the length variables cancel each other out, so that for a capillary of any length, the volume to surface area ratio=i.d./4. In preferred embodiments, the volume to surface area ratio is low—for example, of or less than 125 μm (corresponding to an i.d. of 500 μm). The volume to surface area ratio may be even lower, such as of or less than 100 μm, 75 μm, 50 μm, 40 μm, 35 μm, 30 μm, 25 μm or even 20 μm or less.

In the prior art, modifying the inner surface of a fused-silica capillary has typically been performed using liquid phase coatings which is challenging and in fact impossible for long lengths of small internal-diameter capillaries. Using vacuum and MLD, with optional CVD of an anchor layer, may overcome one or more of the issues of using a liquid reagent and also provide improved efficiency of coverage. The vaporization may be viewed as a conversion into the gaseous phase. Using sequential chemical reactions allows the construction of a well-defined inner surface coating including dimeric, oligomeric and polymeric through MLD (molecular layer deposition) on the surface which provides an impermeable coating. Using vapour as opposed to liquid allows for the monomers to be applied without dilution for greater coating efficiency and better coverage. Further, using monomers, which tend to be smaller chemical species than those used in liquid deposition techniques with ready-made polymer species in a solution, may reduce intermolecular forces between the chemical species allowing for higher density covering to be achieved. That is, the monomers may react with a higher proportion of the silanol groups on the inner surface of the fused silica capillary than can be achieved with liquid deposition techniques employing ready-made polymer species in a solution; they may cover most or all unreacted silanol groups on the inner surface of the fused silica capillary. The MLD approach of building the coating by individual layers allows exquisite control of the surface chemistry—for example hydrophobicity, charge, etc.—to allow the surface to be tuned for specific applications such as separation conditions for capillary electrophoresis.

In preferred embodiments, the enclosed article comprises a silica; that is, is at least in part made up of a silica material. Thus, the enclosed article may be a siliceous enclosed article. As one example, the enclosed article may be a fused silica capillary. Fused silica capillaries typically comprise a fused silica inner layer and a polymeric exterior coating. The inner surface of the fused silica capillary comprises silanol groups, which are capable of reaction with a suitable anchor layer composition, such as a silane coupling agent.

Alternatively, the enclosed article, such as capillary, may have a surface composition of any constitution, with an exposed reactive functional group on the surface. The exposed reactive functional group may be one of the functional groups described in detail below in the context of anchor layer compositions and monomers.

Coated capillaries as formed by the methods of the present invention have special applicability in capillary electrophoresis applications, and particularly in the separation and detection of residues containing target analytes. The target analytes may be inorganic ions associated with explosive detection, inorganic anions indicating residues remaining on a surface after cleaning of a surface, or organic substances such as viruses, pharmaceuticals and other drug substances and their precursors. This includes clandestine materials, and as such the coated capillaries may be used to identify locations that have been used for the production of clandestine materials.

### Anchor Layer Composition

In preferred embodiments, an anchor layer composition is applied to the native inner surface of the enclosed article (e.g. capillary) in a preliminary step.

The anchor layer composition is reacted with the native inner surface of the enclosed article (such as a silica capillary inner surface) to provide an anchor layer on the inner surface of the enclosed article.

The anchor layer may be applied using the liquid flushing technique of the prior art, though it is preferably performed using CVD as described herein. The anchor layer composition and its application is described in the following for application by the process of CVD.

The reaction occurs between functional groups. The native inner surface of the enclosed article contains an exposed functional group, and the anchor layer composition comprises a compound with a functional group that, during CVD, is reactive with the exposed functional group of the native inner surface. The reaction forms a connecting functional group between them.

Once applied, the anchor layer composition is then reacted with a first monomer to provide a first monomer layer on the inner surface of the enclosed article. Accordingly, the anchor layer composition comprises a functional group that is described as an exposed functional group for reacting with a reactive functional group of the first monomer. That is, the anchor layer composition contains two important functional groups: the reactive functional group (for reacting with the exposed functional group of the native inner surface of the enclosed article), and the exposed functional group (for reacting with a reactive functional group of the first monomer).

An anchor layer composition (including the chemical species) differs from a monomer in that the chemical species of the anchor layer composition has a different chemical structure to that of the first, second or subsequent monomer.

In preferred embodiments described below, the native inner surface of the enclosed article contains an exposed silanol functional group, and therefore the anchor layer composition preferably comprises a reactive alkoxysilane or a halosilane functional group. This is particularly suited to fused silica capillaries. However, it is conceivable that the inner surface of the enclosed article is of a different composition, and comprises different exposed functional groups and so the anchor layer composition may be selected from a wider range of reagents. These are described in the following three paragraphs before further discussion of the preferred examples.

Example of applicable exposed functional groups of the native inner surface of the enclosed article and of reactive functional groups of the anchor layer composition, especially in unassisted reactions, are as follows (example connecting functional groups formed between them are given in parenthesis): carboxylic acid and primary amine (secondary amide), carboxylic acid and secondary amine (tertiary amide), carboxylic acid and alcohol (ester), carboxylic acid and hydrazide, carboxylic acid and hydrazine (hydrazide), halosilane and primary amine (secondary aminosilane), halosilane and secondary amine (tertiary aminosilane), halosilane and alcohol (siloxane), haloalkyne and sulfonic acid (sulfonyloxyalkene), alkyne and primary amine (secondary aminoalkene), alkyne and secondary amine (tertiary aminoalkene), azide and alkyne (triazole), conjugated dienes and alkenes (Diels-Alder; cycloalkene), nitrone and alkene (isoxazolidine), nitrone and alkyne, epoxide and primary amine (secondary β-amino alcohol), epoxide and secondary amine (tertiary β-amino alcohol), epoxide and alcohol (ether), epoxide and hydrazide, epoxide and hydrazine (hydrazide), anhydride and primary amine (imide), anhydride and secondary amine (tertiary amide), anhydride and alcohol (ester), anhydride and hydrazide, anhydride and hydrazine (hydrazide), aldehyde and primary amine (imine), aldehyde and secondary amine (enamine), aldehyde and alcohol (hemiacetal), aldehyde and hydrazide (semicarbazone), aldehyde and hydrazine (hydrazone), ketone and primary amine (imine), ketone and secondary amine (enamine), ketone and alcohol (hemiketal), ketone and hydrazide (semicarbazone), ketone and hydrazine (hydrazone), ester and primary amine (secondary amide), ester and secondary amine (tertiary amide), ester and alcohol (ester), ester and hydrazide, ester and hydrazine (hydrazide), isocyanate and primary amine (secondary urea), isocyanate and secondary amine (tertiary urea), isocyanate and alcohol (carbamate), isothiocyanate and primary amine (secondary thiourea), isothiocyanate and secondary amine (tertiary thiourea), isothiocyanate and alcohol (isothiocarbamate), acyl halide and primary amine (secondary amide), acyl halide and secondary amine (tertiary amide), acyl halide and alcohol (ester), acyl halide and hydrazide, acyl halide and hydrazine, thiol and alkene (thiolether), thiol and alkyne (alkenyl sulfide), and silanol and alkoxysilane (siloxane).

For example, when the exposed functional group of the native inner surface of the enclosed article is a carboxylic acid, then the reactive functional group of the anchor layer composition may be primary amine, secondary amine, alcohol, hydrazide or hydrazine. In another example, when the functional group of the exposed native inner surface of the enclosed article is a primary amine, then the reactive functional group of the anchor layer may be carboxylic acid, halosilane, alkyne, epoxide, anhydride, aldehyde, ketone, ester, isocyanate, isothiocyanate or acyl halide. The same applies to all combinations of functional groups listed above, without limitation.

Similarly, the functional groups may be selected based on the connecting functional group formed. For example, a tertiary amide connecting functional group may be formed when the exposed functional group of the native inner surface of the enclosed article is carboxylic acid, anhydride, ester or acyl halide, by using an anchor layer composition with a reactive functional group that is secondary amine (or vice versa). Again, the same applies to all connecting functional groups formed by the combinations of functional groups listed above, without limitation.

In the preferred embodiments where the enclosed article is a fused silica capillary, the exposed functional group of the native inner surface comprises silanol groups which are capable of unassisted reaction with an alkoxysilane or halosilane reactive functional group of an anchor layer composition.

Accordingly, in preferred embodiments, the native inner surface of the enclosed article contains an exposed silanol functional group and the anchor layer composition comprises a reactive alkoxysilane or a halosilane functional group.

Examples of applicable exposed functional groups of the anchor layer and reactive functional groups of the first monomer, especially in unassisted reactions, are the same as those given above in respect of the exposed native inner surface functional group and the reactive anchor layer functional group with equal applicability. The exposed anchor layer functional group may be selected from the group consisting of: carboxylic acid; primary amine; secondary amine; alcohol; hydrazide; hydrazine; halosilane; haloalkyne; sulfonic acid; alkyne; azide; conjugated diene; alkene; nitrone; epoxide; anhydride; aldehyde; ketone; ester; isocyanate; isothiocyanate; acyl halide; thiol; silanol; and alkoxysilane.

Preferably, the anchor layer composition exposed functional group is not one that would lead to the first monomer having a reactive functional group that would also be reactive with the exposed native inner surface functional group. Put another way, preferably the anchor layer composition exposed functional group is not the same as (i.e. is distinct from) the exposed native inner surface functional group. This is because, at times, the application of an anchor layer to a native inner surface may not be complete, as in there may be residual exposed native inner surface functional groups that have not reacted. As it is desirable to achieve a controlled surface composition with uniform and controlled polymer length, then it is preferred that the first monomer does not react with the native inner surface, and accordingly that the reactive first monomer functional group is not reactive with the native inner surface functional group (when an anchor layer is used). Accordingly, in preferred embodiments where the native inner surface of the enclosed article contains a silanol functional group, the exposed anchor layer functional group is not also a silanol functional group.

Thus, in preferred embodiments, the exposed anchor layer functional group is selected from the group consisting of an amine, anhydride, aldehyde, epoxide, hydrazide, alcohol, isocyanate, isothiocyanate, alkene or a thiol, more preferably selected from the group consisting of an amine and epoxide.

Suitable anchor layer compositions may comprise a silane. That is, the anchor layer composition may comprise a silane coupling agent. Silane coupling agents are a well-known class of reagents in the art of the invention. Silane coupling agents are described fully in Arkles, B., Silane Coupling Agents: Connecting Across Boundaries (Version 3.0). J. Organomet. Chem. 2014, 3(1), 1-76, the entirety of which is hereby incorporated by reference.

Silane coupling agents have the ability to react with the native inner surface of the enclosed article, such as with exposed silanol functional groups of a fused silica capillary, to provide an anchor layer on the inner surface of the enclosed article. Suitable silanes may have the formula:

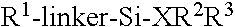

where R¹ is an organofunctional group (also referred to as the exposed anchor layer functional group), “linker” is an organic linking group, X is a hydrolysable group (also referred to as the reactive anchor layer composition functional group), and R² and R³ are each independently selected from hydrolysable groups and C₁-C₁₂ alkyl groups.

The R¹ group, forming the exposed anchor layer functional group, may be selected as described above, and is preferably selected from the group consisting of an amine, anhydride, aldehyde, epoxide, hydrazide, alcohol, isocyanate, isothiocyanate, alkene or a thiol, and more preferably selected from the group consisting of an amine and an epoxide.

The linker group is an inert organic linking group. The linker group may, for example, be selected from the group consisting of a linear or branched C₁-C₁₂ alkyl, halogenated or per- or poly-halogenated C₁-C₁₀ alkyl and C₁-C₁₀ alkyloxy-C₁-C₁₀alkyl.

The hydrolysable group is suitably selected from alkoxy, acyloxy, halogen or amine. Alkoxy and acyloxy groups may be C₁-C₆ alkyloxy or acyloxy groups. Alkoxy and halogen hydrolysable groups are especially suitable in the case of fused silica enclosed articles (e.g. capillaries) which have exposed silanol groups, as alkoxy and halogen hydrolysable groups react unassisted with said exposed silanol groups.

R² and R³ are each independently selected from hydrolysable groups (i.e. X) and C₁-C₁₂ alkyl groups. In some embodiments, each of R² and R³ are X, such that the silane reactive compound is R¹-linker-Si—X₃.

Examples of suitable anchor layer compositions are the silane coupling agents 3-Glycidoxypropyltrimethoxysilane (GPTMS), (3-Aminopropyl)trimethoxysilane (APTMS) and (3-mercaptopropyl)trimethoxysilane (MPTMS).

The silane coupling agent is hydrolysable at the hydrolysable functional group (X), and following hydrolysis a reactive silanol group is formed, which can condense with the silanol groups on the native inner surface of a fused silica capillary. This results in the formation of a monolayer of the anchor layer composition on the inner surface of the capillary, with an exposed anchor layer functional group (R¹).

The silane coupling agent is suitably vaporizable and not self-reacting such that it forms dimers, trimers etc. under the applied conditions of application to the inner surface of the capillary. This allows for the CVD techniques for the application of the anchor layer on the capillary surface. The CVD conditions may be elevated temperature and vacuum.

The temperature is suitably at least 20° C., at least 30° C., at least 40° C., at least 50° C., at least 60° C., at least 70° C., at least 80° C., at least 90° C. or at least 100° C. By applying vacuum, the temperature can be kept to a minimum, while still ensuring vaporization of the silane coupling agent for CVD of the agent on the inner surface of the capillary.

The vacuum may suitably apply a negative pressure (relative to atmospheric pressure) of at least 700 mbar, at least 600 mbar, at least 500 mbar, at least 400 mbar, at least 300 mbar, at least 300 mbar, at least 100 mbar, at least 70 mbar or at least 50 mbar. Most preferably, the vacuum applies a negative pressure of about 70 mbar. This pressure has been found to be applicable to a wide range of anchor layer compositions, allowing vaporization at temperatures within the usable range of common heating devices.

Accordingly, the temperature is suitably at most 120° C., at most 110° C., at most 100° C., at most 90° C., at most 80° C., at most 70° C., at most 60° C. or at most 50° C. Any minimum and maximum temperature can be sensibly combined without restriction. For example, the temperature may be between 20° C. and 50° C., 20° C. and 120° C., 100° C. and 120° C. etc., depending on the negative pressure applied and the temperature required to vaporize an anchor layer composition at that negative pressure.

### Monomers

A monomer is a single chemical species that is not self-reacting under the conditions used to perform the methods of the invention. A monomer is an organic chemical species, being a carbon-containing compound excluding inorganic carbides, carbonates, carbon oxides and carbon-only compounds (e.g. graphite). Salts of organic compounds, including metal salts, are organic chemical species. A monomer that is an organic chemical species will form a monomer layer that is an organic material as opposed to an inorganic material.

### First Monomer

A first monomer layer is applied to the inner surface of the enclosed article (e.g. capillary).

The first monomer layer is reacted with the native inner surface of the enclosed article or with a pre-applied anchor layer to provide a first monomer layer on the inner surface of the enclosed article as described herein. The reaction occurs between functional groups. The native inner surface or the anchor layer of the inner surface of the enclosed article contains an exposed functional group, and the first monomer comprises a reactive functional group that, during MLD, is reactive with the exposed functional group. The reaction forms a connecting functional group between them.

The monomer is suitably vaporizable and is not self-reacting such that it forms different chemical species (dimers, trimers etc.) under the conditions being applied in a single step. Those conditions are typically heat and/or vacuum as described herein. In preferred embodiments, an anchor layer is used as described above, and accordingly in preferred embodiments the first monomer is reacted with the anchor layer and as such contains a reactive functional group that is reactive with the exposed functional group of an anchor layer, but which is—as described above—preferably not reactive with the exposed functional group of the native inner surface of the enclosed article. This application to an anchor layer will be described in the following, though without limitation.

Examples of applicable exposed functional groups of the anchor layer of the enclosed article and of reactive functional groups of the first monomer (along with example connecting functional groups formed between them) are the same as those described above in respect of the exposed functional groups of the native inner surface and the reactive functional groups of the anchor layer composition with equal applicability. This includes the preference that, when an anchor layer is used, the first monomer does not react with the native inner surface, and accordingly that the reactive first monomer functional group is not reactive with the native inner surface functional group. Accordingly, in preferred embodiments where the native inner surface of the enclosed article contains a silanol functional group, the first monomer functional group is not reactive with a silanol functional group.

The preferred exposed anchor layer functional groups are listed above. Accordingly, the preferred reactive functional group of the first monomer that is reactive therewith is selected from the group consisting of (with the preferred exposed anchor layer functional groups in parenthesis): carboxylic acid, halosilane, alkyne, epoxide, anhydride, aldehyde, ketone, ester, isocyanate, isothiocyanate, acyl halide (these are preferred where the exposed anchor layer functional group is an amine—primary or secondary); primary amine, secondary amine, alcohol, hydrazide, hydrazine (these are preferred where the exposed anchor layer functional group is an anhydride); primary amine, secondary amine, alcohol, hydrazide, hydrazine (these are preferred where the exposed anchor layer functional group is an aldehyde); primary amine, secondary amine, alcohol, hydrazide, hydrazine (these are preferred where the exposed anchor layer functional group is an epoxide); carboxylic acid, epoxide, anhydride, aldehyde, ketone, ester, acyl halide (these are preferred where the exposed anchor layer functional group is hydrazide); carboxylic acid, halosilane, epoxide, anhydride, aldehyde, ketone, ester, isocyanate, isothiocyanate, acyl halide (these are preferred where the exposed anchor layer functional group is an alcohol); primary amine, secondary amine, alcohol (these are preferred where the exposed anchor layer functional group is an isocyanate); primary amine, secondary amine, alcohol (these are preferred where the exposed anchor layer functional group is an isothiocyanate); conjugated diene, nitrone, thiol (these are preferred where the exposed anchor layer functional group is an alkene); and alkene, alkyne (these are preferred where the exposed anchor layer functional group is a thiol).

The more preferred exposed anchor layer functional group is selected from the group consisting of an amine and epoxide. Accordingly, the more preferred first monomer reactive functional group is selected from the group consisting of: carboxylic acid, halosilane, alkyne, epoxide, anhydride, aldehyde, ketone, ester, isocyanate, isothiocyanate, acyl halide, primary amine, secondary amine, alcohol, hydrazide and hydrazine.

In preferred embodiments, once applied, the first monomer is reacted with a second monomer to provide a second monomer layer on the inner surface of the enclosed article. Accordingly, in preferred embodiments, the first monomer comprises an exposed functional group for reacting with a reactive functional group of the second monomer. That is, the first monomer preferably contains two important functional groups: the reactive functional group (for reacting with the exposed functional group of the native inner surface of the enclosed article or the exposed functional group of the anchor layer, preferably the latter), and the exposed functional group (for reacting with a reactive functional group of the second monomer).

Example of applicable exposed functional groups of the first monomer and reactive functional groups of the second monomer, especially in unassisted reactions, are the same as those given above in respect of the exposed native inner surface functional group and the reactive anchor layer functional group, with equal applicability. That is, for example, the first monomer exposed functional group may be selected from the group consisting of: carboxylic acid; primary amine; secondary amine; alcohol; hydrazide; hydrazine; halosilane; haloalkyne; sulfonic acid; alkyne; azide; conjugated diene; alkene; nitrone; epoxide; anhydride; aldehyde; ketone; ester; isocyanate; isothiocyanate; acyl halide; thiol; silanol; and alkoxysilane.

### Second and Subsequent Monomer

Like for the first monomer and for the same reasons as described above, preferably the second monomer does not react with the native inner surface, and accordingly the reactive second monomer functional group is preferably not reactive with the native inner surface functional group. Accordingly, in preferred embodiments where the native inner surface of the enclosed article contains a silanol functional group, the second monomer functional group is not reactive with a silanol functional group. This applies also to all third and subsequent monomers.

In preferred embodiments, the first monomer exposed functional group is selected from the group consisting of an amine, anhydride, aldehyde, epoxide, hydrazide, alcohol, isocyanate, isothiocyanate, alkene or a thiol, more preferably selected from the group consisting of an amine.

The second monomer reactive functional group may thus be selected accordingly, and in preferred embodiments may be selected from the group consisting of (with the preferred first monomer exposed functional group in parenthesis): carboxylic acid, halosilane, alkyne, epoxide, anhydride, aldehyde, ketone, ester, isocyanate, isothiocyanate, acyl halide (these are preferred where the first monomer exposed functional group is an amine—primary or secondary); primary amine, secondary amine, alcohol, hydrazide, hydrazine (these are preferred where the first monomer exposed functional group is an anhydride); primary amine, secondary amine, alcohol, hydrazide, hydrazine (these are preferred where the first monomer exposed functional group is an aldehyde); primary amine, secondary amine, alcohol, hydrazide, hydrazine (these are preferred where the first monomer exposed functional group is an epoxide); carboxylic acid, epoxide, anhydride, aldehyde, ketone, ester, acyl halide (these are preferred where the first monomer exposed functional group is a hydrazide); carboxylic acid, halosilane, epoxide, anhydride, aldehyde, ketone, ester, isocyanate, isothiocyanate, acyl halide (these are preferred where the first monomer exposed functional group is an alcohol); primary amine, secondary amine, alcohol (these are preferred where the first monomer exposed functional group is an isocyanate); primary amine, secondary amine, alcohol (these are preferred where the first monomer exposed functional group is an isothiocyanate); conjugated diene, nitrone, thiol (these are preferred where the first monomer exposed functional group is an alkene); and alkene, alkyne (these are preferred where the first monomer exposed functional group is a thiol).

The more preferred first monomer exposed functional group is selected from the group consisting of an amine. Accordingly, the more preferred second monomer reactive functional group is selected from the group consisting of: carboxylic acid, halosilane, alkyne, epoxide, anhydride, aldehyde, ketone, ester, isocyanate, isothiocyanate and acyl halide, and more preferably an aldehyde.

The second monomer also comprises a second monomer exposed functional group. These may be selected from the list of options for the preferred anchor layer exposed functional groups outlined above. The second monomer exposed functional group is preferably the same as the second monomer reactive functional group. As one example, the second monomer may be a dialdehyde. This then allows for the application of another first monomer layer on the second monomer layer by the same technique as described herein, for the formation of a polymer from the alternating layers of first and second monomers.

Second, third, fourth, fifth and subsequent monomers may also be applied to the inner surface of the enclosed article in successive MLD steps for controlled dimer, trimer, oligomer and polymer growth, and may be selected as described above in respect of the first (and second) monomers. The number of monomers applied may be as few as 1, 2, 3 or 4 and may be more, for example at least 5, 10, 15, 20 or 25 or more, such as 30, 40, 50, 60, 70, 80 etc. or 100 or more, for example 150, 200, 250 or more. The number of monomers applied may be determined by the particular application at hand and may be, for example any integer of between 1 and 100, or 1 and 750, or 1 and 500 or 1 and 250. For example, for applications of coated fused silica capillaries in electrophoresis, the number of monomers applied may be between 10 and 250, or between 20 and 225, or between 30 and 200, or between 40 and 175, or between 50 and 150, such as between 75 and 125 or between 85 and 115.

Apart from the functional groups and properties as described and defined, the chemical structure of the first, second, third and subsequent monomers is not particularly limited, as long as the monomers are each a single chemical species, suitably vaporizable, and not self-reacting during MLD under the preferred reduced pressure and increased temperature conditions. Monomers will generally be selected based on the desired polymer to be formed. Polymers are often defined by the connecting functional groups between the monomers, for example (with the connecting functional groups given in parenthesis) polyesters (ester), polyurethanes (carbamate), polyamides (amide), polyimides (imide), polyazomethines (azomethine), polyureas (urea), polythioureas (thiourea) and thiolenes (thioether). Numerous polymers falling into these categories can be formed by the methods of the present application by selecting the exposed and reactive functional groups of the monomers such that these connecting functional groups are formed.

Various specific polymers and their monomers are also known, for example those known by trade names Kevlar (monomers p-phenylenediamine and terephthalaldehyde or terephthaloyl chloride), Nylon 66 (monomers hexamethylenediamine and adipic acid), Twaron (monomers p-phenylene diamine and terephthaloyl chloride), Nomex (monomers m-phenylenediamine and isophthaloyl chloride), Technora (monomers terephthaloyl chloride, p-phenylenediamine and 3,4′-diaminodiphenylether), Vectran (monomers 4-hydroxybenzoic acid and 6-hydroxynaphthalene-2-carboxylic acid), Zylon (monomers p-phenylene-2,6-benzobisoxazole) and PET (monomers terephthalic acid and ethylene glycol). Monomers for the production of these and other polymers may be selected, choosing reagents having reactive chemical structures and functional groups accordingly.

Examples of suitable monomers include many of those as described in Meng, X, An overview of molecular layer deposition for organic and organic-inorganic hybrid materials: mechanisms, growth characteristics, and promising applications, J. Mater Chem., 2017, 5, 18326-78, the entirety of which is hereby incorporated by reference.

The preferred polymers for which suitable monomers may be selected include polyimides, polyazomethines, polyureas, polyamides, polythioureas, polyethylene terephthalate and polythioethers. The preferred polymers for which suitable monomers may be selected are alternating copolymers, in which the second monomer is preferably different to the first monomer. Third, fourth and subsequent monomers may be selected accordingly. For example, the fourth monomer may be identical to the second monomer, etc.

The reactive functional group of the first monomer and the exposed functional group of the first monomer are preferably the same. That is, the first monomer is preferably difunctional. The difunctional monomers can be deduced from the lists of reactive functional groups and exposed functional groups outlined above. Examples include diamine monomers, dianhydride monomers, dicarboxylic acids, dialdehydes, diacyl halides, diepoxides, diisocyanates, dithioisocyanates, dialcohols, dienes and dithiols. The second monomer is also preferably difunctional. Examples include diamine monomers, dianhydride monomers, dicarboxylic acids, dialdehydes, diacyl halides, diepoxides, diisocyanates, dithioisocyanates, dialcohols, dienes and dithiols. The pair will be selected to ensure that the functional groups of the first monomer react with the functional groups of the second monomer.

The preferred monomers and polymers formed are as follows in Table 1:

TABLE 1
Preferred monomers and polymers formed.

| | | |
|---|---|---|
| Monomer 1 | Monomer 2 | Polymer |

Polyimides

| | | |
|---|---|---|
| Pyromellitic dianhydride | 4,4′-Diaminodiphenyl ether or 4,4′-oxydianilie | 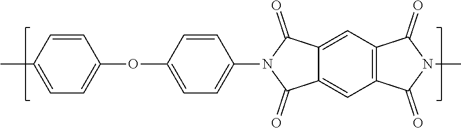 |
| Pyromellitic dianhydride | 2,4-Diamino- nitrobenzene | 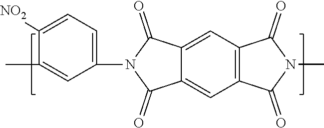 |
| Pyromellitic dianhydride | p-Phenylenediamine | 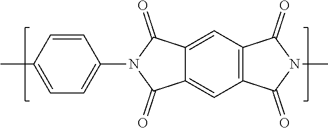 |
| Pyromellitic dianhydride | Ethylene diamine | 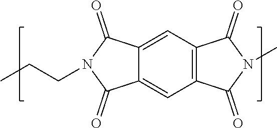 |
| Pyromellitic dianhydride | 1,6-hexenediamine | 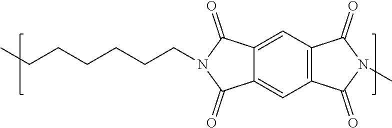 |

Polyazomethines

| | | |
|---|---|---|
| Terephtalaldehyde | p-Phenylenediamine | 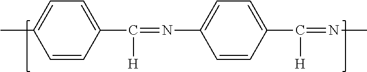 |
| Terephthalaldehyde | Oxalic dihydrazide | 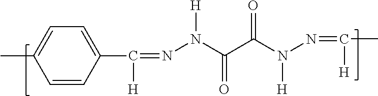 |

Polyureas

| | | |
|---|---|---|
| 1,4-phenylene diisocyanate | Ethylene diamine | 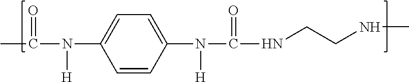 |
| 1,4-phenylene diisocyanate | 2,2-′thiobisethylamine | 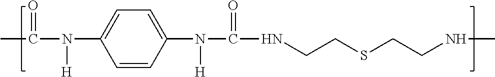 |
| 1,4-phenylene diisocyanate | 2,2′(propane-2,2- diylbis(oxy)) diethanamine | 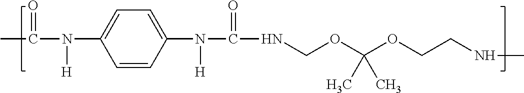 |
| 1,4-phenylene diisocyanate | p-Phenylenediamine | 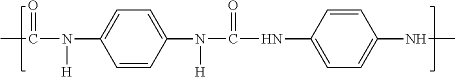 |
| 1,4- diisocyanatobutane | Ethylenediamine | 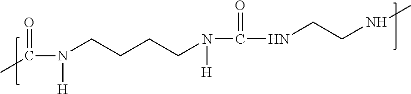 |
| 1,4- diisocyanatobutane | Diethylenetriamine | 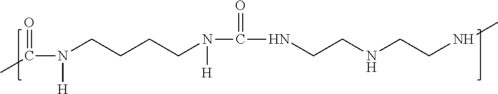 |
| 1,4- diisocyanatobutane | Triethylenetetramine | 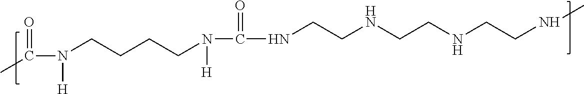 |
| 1,4- diisocyanatobutane | Tris(2- aminoethyl)amine | 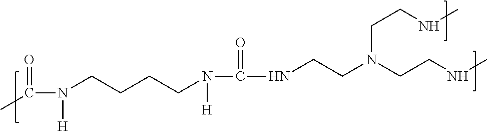 |

Polyamides

| | | |
|---|---|---|
| 1,6-hexanediamine | Adipoyl chloride | 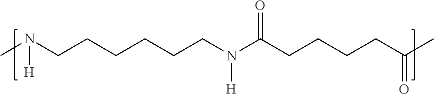 |
| p-Phenylenediamine | Terephthaloyl chloride or terephthalaldehyde | 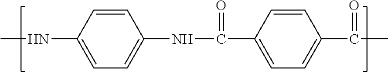 |
| 1,4-butanediamne | Terephthaloyl chloride or terephthalaldehyde | 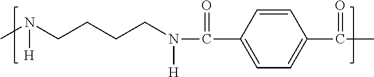 |

Polythiolurea

| | | |
|---|---|---|
| Ethylenediamine | 1,4-phenylene diisothiocyanate | 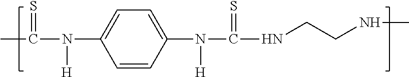 |

Polyethylene terephthalate

| | | |
|---|---|---|
| Ethylene glycol | Terephthaloyl chloride or terephthalaldehyde | 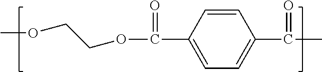 |

Thiol-enes (polythioethers)

| | | |
|---|---|---|
| 1,7-octodiene | 1,2-ethanedithiol | 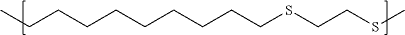 |
| 1,7-octodiene | 1,4-butanedithiol | 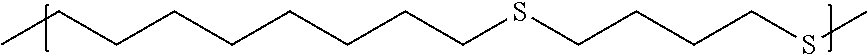 |
| 1,7-octodiene | 1,10-decanedithiol | 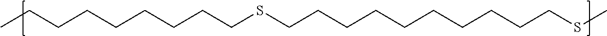 |
| 1,7-octodiene | 1,4- benzene- dimethanethiol | 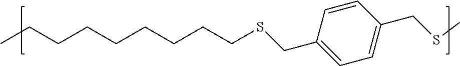 |
| 1,7-octodiene | 1,4-benzenedithiol | 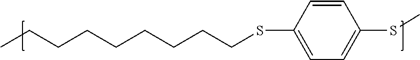 |
| 1,11-dodecadiene | 1,10-decanedithiol | 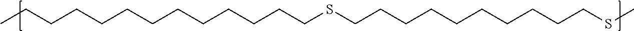 |

For the application of monomers using MLD, the temperature is suitably at least 20° C., at least 30° C., at least 40° C., at least 50° C., at least 60° C., at least 70° C., at least 80° C., at least 90° C. or at least 100° C. By applying vacuum, the temperature can be kept to a minimum, while still ensuring vaporization of the monomer for application to the inner surface of the capillary in the vapor phase. The vacuum may suitably apply a negative pressure (relative to atmospheric pressure) as described above in relation to the anchor layer (silane coupling agent) with equal applicability to applying monomers, including the most preferred negative pressure of about 70 mbar for the reasons given above.

At negative pressure, for the application of monomers the temperature is suitably at most 180° C., at most 170° C., at most 160° C., at most 150° C., at most 140° C., at most 130° C., at most 120° C. or at most 110° C. Any minimum and maximum temperature can be sensibly combined without restriction. For example, the temperature may be between 20° C. and 180° C., 20° C. and 110° C., 110° C. and 180° C. etc., depending on the negative pressure applied and the temperature required to vaporize a monomer at that negative pressure.

### Other Coating Steps

In addition to the intermediate step of applying an anchor layer, other intermediate steps are applicable, though are not essential.

As explained above, at times there may be residual native surface exposed functional groups remaining after application of the anchor layer (or application of the first monomer, whatever the case may be). It is preferred that the any subsequent monomer does not react with the native surface as explained above.

In the preferred embodiment described this may be controlled by appropriate selection of functional groups. An alternative or additional way to prevent this involves an intermediate step of capping the residual native surface exposed functional groups after application of the anchor layer (or first monomer). This may involve an intermediate CVD step of treating the inner surface with a capping reagent, the capping reagent including a functional group that is reactive with the native inner surface of the enclosed article but not with the exposed functional group of the anchor layer (or applied monomer). A capping reagent suitably is vapourisable, not self-reacting, and once applied does not provide an exposed functional group that is reactive with the reactive functional group of any subsequent monomer.

In the case of fused silica capillaries which have a native surface with exposed silanol functional groups, suitable end-capping monomers include those with alkoxysilane or halosilane reactive functional groups. Specific examples are trichloromethylsilane (MTS) and trichlorophenylsilane (PTS), which include halosilane reactive functional groups, but do not contain an exposed functional group that is reactive with many of the reactive functional groups of monomers as described above.

Another intermediate step that may be performed involves the chemical conversion of an exposed functional group from one type into another. This assists to provide flexibility in the reagents selected for the monomers. This may involve an intermediate CVD step of treating the inner surface with a reactive reagent. Such a reactive reagent is suitably vapourisable and is not self-reacting. Examples of chemical conversion of functional groups with reactive reagents include the conversion of an epoxide to an amine using ammonia reagent, and conversion of an epoxide to a hydroxide using sulphuric acid reagent. Many other examples are known or determinable to the person skilled in the art.

In addition to intermediate steps, once a desired polymer growth has taken place, or the desired monomers have been applied, an additional step may be used to cap the polymer chain, apply a suitable substrate thereto, or chemically convert an exposed functional group from one type into another. This allows for the termination of the polymer chain and/or the application of suitable functional group or substrates to the end of the polymer chain. This may be desirable in instances where, for example, the enclosed article requires a particular exposed functional group or substrate, or the absence of an exposed functional group that may be reactive.

### Apparatus and Method Steps

In the following discussion, reference is made to coating of a capillary for the sake of brevity. Nevertheless, the discussion applies equally to the application of inner surface coatings on other enclosed articles as described above.

The method of the present application involves production of an inner surface coating on an enclosed article. In preferred embodiments, the enclosed articles is coated only on its inner surface, in which case it may be said that a coating is applied to an enclosed article in a region consisting of an inner surface of the enclosed article or a portion thereof. Accordingly, the application of monomers to an enclosed article is preferably only to its inner surface, in which case it may be said that a monomer is applied to an enclosed article in a region consisting of an inner surface of the enclosed article or a portion thereof. Preferably, areas other than the inner surface are not exposed to a monomer. Or in other words, the exposure of an enclosed article to monomers in the methods of the invention is to the inner surface only; the exposure of an enclosed article to monomers is in a region consisting of an inner surface of the enclosed article or a portion thereof. This differs from prior art deposition techniques which apply coatings to open (i.e. outer) surfaces of articles. This generally involves placing an article in a chamber and passing a flow of coating composition over the outer surface. It is possible using the apparatus described herein to expose monomers only to the surface desired to be coated—the inner surface.

The method of the present application involves a series of steps performed to apply coatings on a capillary, including a series of steps for the vaporization of the reagent (i.e. the anchor layer composition or monomer), drawing the vapor through the capillary, and allowing for the reaction of the reagent with the exposed functional groups on the inner surface of the capillary.

In preferred embodiments, each of the vaporization and reaction steps is performed under the application of a pressure differential. This may be by way of a positive pressure or a negative pressure (relative to atmospheric pressure). When a positive pressure is used, a carrier gas which is inert may be used to pass the reagents through the enclosed article under positive pressure. The positive pressure may be facilitated by way of a pressurized inert gas source or a pressure pump positioned up-stream of the enclosed article.

An inert gas is one which may be passed through the capillary without reacting with the native inner surface, or with any coating applied or any reagents used. The inert gas may be the same at each CVD or MLD step, or different, depending on the chemical nature of the coated inner surface, the reagents and the gas. Nitrogen gas (N) is widely applicable and preferred, though other inert gases are applicable, for example argon, helium, carbon dioxide, oxygen, air or a vaporized solvent may be used as inert gases depending on the chemical nature of the native inner surface, coating applied, and reagents used.

Preferably the steps are performed under the application of vacuum (negative pressure) applied at one end of the enclosed article (e.g. capillary) opposite to the inlet end through which the vaporized reagents enter the enclosed article (i.e. downstream of the enclosed article). This may be achieved using a vacuum pump. This is advantageous as a means for drawing the vaporized anchor layer composition and monomers through the enclosed articles (e.g. capillaries). This also permits vaporization of the monomers to be achieved under reduced temperatures as compared to the vaporization temperatures at atmospheric pressure. This also allows for removal of the need for a carrier gas and allows for the monomer to be used without dilution thus creating a saturated environment for improved coating efficiency, coverage coating density and applicability to longer capillaries. As noted above, the reactions that the anchor layer and monomer undergo may generate byproducts that need to be flushed away from the inner surface. The drawing of the gas flow through the enclosed article (capillary) under vacuum further aids in the effective flushing of the reaction byproducts away from the enclosed article surface.

As described above, the step of forming the anchor layer, applying a capping reagent, forming a monomer layer (first, second, third and subsequent) and chemical conversion of functional groups is all suitably performed by CVD or MLD.

All of these steps are accordingly preferably performed under vacuum. Using vacuum to coat enclosed articles and especially capillaries, decreases the reaction temperature and the boiling point for reagents to convert to vapor, results in a more homogenous monolayer coating of the monomers, and can prevent blockage of the enclosed article during coating. This especially applies to anchor layer compositions which are silanes, as reducing the pressure allows the temperature to be reduced to decrease boiling point to convert them to vapor, and in addition minimizes or eliminates the water effect, being the tendency of these chemical species to degrade and/or self-polymerise in the presence of liquid water.

The temperature and pressure applied may vary depending on the anchor layer composition, monomer or other reagent as described above. By applying vacuum, the temperature can be kept to a minimum, while still ensuring vaporization of the silane coupling agent for CVD of the agent on the inner surface of the capillary.

Between each vaporization and reaction step, the method preferably comprises flushing the enclosed article (e.g. capillary) with an inert gas to purge the enclosed article of excess reagent and any reaction by-products. This assists to ensure that all unreacted or physiosorbed reagents and by-products have exited the capillary before the next layer is applied.

In another aspect, the present invention provides an apparatus for forming an inner surface coating on an enclosed article (such as a capillary), the apparatus comprising:
a heating chamber
a reagent vessel
connectors for fluid connection of the enclosed article with and preferably between the reagent vessel and a vacuum pump so that the enclosed article will be positioned within the heating chamber and in fluid connection with and preferably between the regent vessel and a vacuum pump when connected;
   whereby, in operation, a reagent can be vaporized in the reagent vessel under vacuum and/or upon the application of heat, and the vaporized reagent can pass into and preferably through the enclosed article for reaction with the inner surface of the enclosed article for the formation of a coating of the inner surface of the enclosed article.

The connectors for fluid connection of the enclosed article and the reagent vessel for passing vaporized reagent into the enclosed article allow for the inner surface to be exposed to reagents while avoiding the outer surface being exposed to the reagents. In other words, the connectors are configured to expose reagents to an area of the enclosed article consisting of the inner surface or a portion thereof. This differs from open surface deposition techniques in which a composition is passed over an article surface in a chamber. Using the described apparatus, only the surface to be coated is exposed which provides for more coating only of the desired surface, less reagent waste, lower reagent volumes and improved coating efficiency. Suitably the connectors will provide a suitable seal, including in embodiments utilizing a differential pressure.

The apparatus may further comprise a condenser for condensing any condensable vapors that emerge from the enclosed article, preferably positioned externally to the heating chamber and upstream of any connected vacuum pump. The apparatus may also comprise a valve for controlling the vapor flow into the enclosed article. The valve may be operable to control between the flow of vaporized reagent into the capillary. The valve may also allow the capillary to be disconnected from the reagent vessel, to allow a second regent to be placed in the reagent vessel for vaporization and passage through the capillary. The use of a valve is also one way in which an enclosed article with only one opening may have a coating applied to its inner surface, by connecting e.g. a selectable three-way valve to each of the opening, reagent vial and vacuum pump. In this way the enclosed article may be evacuated by opening the valve to the enclosed article and vacuum pump, and exposed to the coating vapor by opening the valve to the enclosed article and reagent vial.

In preferred embodiments, the apparatus also comprises a vacuum pump, preferably positioned externally to the heating chamber and downstream of any condenser, for drawing vapors into and preferably through the enclosed article from the reagent vessel. The vacuum may suitably apply a negative pressure (relative to atmospheric pressure) controllable depending on the desired lower boiling point of any given anchor layer composition, monomer or other reagent. Suitable negative pressures are as described above, including in preferred embodiments the vacuum applies a negative pressure of about 70 mbar for the reasons given above.

Accordingly, the heating chamber may suitably be capable of applying a controlled temperature for vaporization of reagents at negative pressure. Suitable temperatures for anchor layer compositions and monomers is described above. Suitable controllable heating chambers include an oven such as may be found in many gas chromatography instruments.

In preferred embodiments, the apparatus also comprises a connector for connecting an inert gas source in fluid connection with the enclosed article. Preferably, the connection is made within the heating chamber and up-stream of the enclosed article. Preferably, an inert gas source is also included, preferably positioned externally to the heating chamber. The connection of the inert gas source may be made via a valve for controlling the inert gas flow into the enclosed article. The valve may be a different valve to the valve for controlling the reagent flow, or it may be the same, for example a two-way valve. The inert gas may be as described above and is preferably nitrogen gas (N₂).

### EXAMPLES

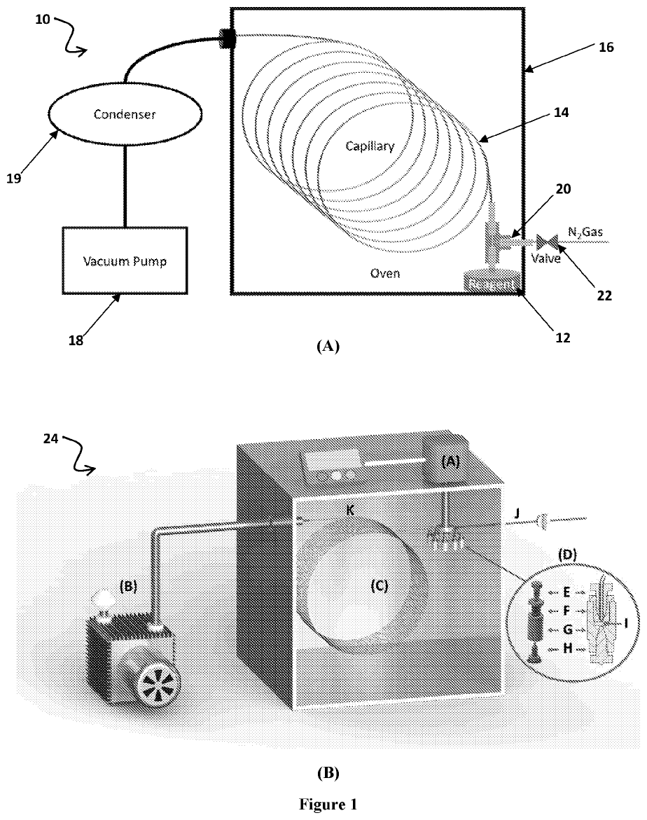

A pictorial representation of the apparatus used to coat the inner surface of an enclosed article, in this case a capillary, using CVD, is presented in FIG. 1.

FIG. 1A shows a manual apparatus, being where the reagent vessel is disconnected and charged with a monomer for each coating step. In its basic components, the apparatus 10 consists of a reagent vessel in the form of a reagent vial 12, inert gas source (not shown), a capillary 14 to which an inner surface coating is to be applied, an oven 16 and a vacuum pump 18, (equipped with a condenser 19). In this instance, the capillary is a fused silica capillary of 500 cm in length and 10 μm internal diameter. The oven is a temperature-controlled gas chromatography oven. The reagent vial 12 contains the monomer to be coated to the capillary inner surface (i.e. the reagent). The apparatus comprises a connector 20 for connecting the reagent vial to one end of the capillary 14 for fluid communication between the reagent vial and the inner surface of the capillary. The connector is in this instance a T-shaped connector. One arm of the T-shaped connector is connected to an inert gas source, in this instance nitrogen (N₂), via an openable and closable valve 22. The valve may be electronically-controlled as part of an automated system (see e.g. FIG. 1B). When the valve 22 is opened, the inert gas comes into fluid communication with the inner surface of the capillary. The reagent vial and capillary are located within the oven 16. The other end of the capillary 14 is connected to a vacuum pump 18 which is in fluid communication with the inner surface of the capillary. A condenser is also provided between the capillary and the vacuum pump (or integrated into the vacuum pump) for condensing any vaporised substances that emerge from the capillary. The connection of the vacuum pump to the capillary is made within the oven.

The general operation of the manual apparatus is as follows. For the coating of the anchor layer composition (where relevant) and each monomer to be coated to the capillary inner surface (or intermediate reagent), the desired reagent is charged to reagent vial 12. In the examples described below, approximately 30 μL of a liquid reagent or 20 mg of the solid reagent is charged into the reagent vial. The capacity of the reagent vial is about 200 μL in volume. The reagent vial is then connected to one end of the capillary 14 via one arm of a t-shaped connector. The capillary and reagent vial are placed inside the oven 16. The nitrogen gas source is also placed in fluid connection with the capillary via the connector 20 and valve 22. The other end of the capillary is connected to the vacuum pump 18, the connection being made within the oven. The oven is sealed, the vacuum pump operated at a constant vacuum of 70 mbar for 10 minutes, and the oven temperature is increased to achieve vaporisation of the reagent in the reagent vial. These conditions are held for about 12 hours. After 12 hrs, and valve 22 is opened to purge the capillary with nitrogen gas for 10 minutes at the same oven temperature, to remove residual reagent from the capillary. The oven temperature is reduced while purging continues, and the valve is closed to stop the flow of nitrogen gas when the temperature reaches 25° C. To apply another reagent (i.e. monomer or intermediate reagent), the reagent vial is detached, cleaned, dried and filled with the next reagent, and the above process repeated.

FIG. 1B shows an automated apparatus, being where the reagent vessel does not need to be disconnected and charged with a monomer for every coating step. In its basic components, the apparatus 24 consists of a series of reagent vials D (in this case, ten) inert gas supply line J, a capillary K to which an inner surface coating is to be applied, an oven C, a vacuum pump B and a selector valve A. Each reagent vial consists of parts E-I and contains a space for adding up to 100 μL of reagent. The capillary and reagent vials are housed within the oven. In this instance, the capillary is a fused silica capillary of 500 cm in length and 10 μm internal diameter. The oven is a temperature-controlled gas chromatography oven. Each reagent vial D contains a monomer to be coated to the capillary inner surface (i.e. the reagent). The selector valve is fluidly connected to one end of the capillary via a connector, while the vacuum pump is fluidly connected to the other end of the capillary via a connector. The selector valve is also connected to an inert gas source, in this instance nitrogen (N₂). The selector valve is selectable between the inert gas source and any one of the reagent vials, and may be electronically controlled. When the inert gas source is selected with the selector valve, the inert gas comes into fluid communication with the inner surface of the capillary.

The general operation of the automated apparatus is as follows. For the coating of the anchor layer composition (where relevant) and each monomer to be coated to the capillary inner surface (or intermediate reagent), the desired reagent is charged individually to a reagent vial D. The reagent vials are then connected to the selector valve A. The capillary and reagent vials are placed inside the oven C, and the selector valve is connected with one end of the capillary K. The nitrogen gas source is also placed in fluid connection with the selector valve A. The other end of the capillary is connected to the vacuum pump B, the connection being made within the oven. The oven is sealed, the vacuum pump is operated and the oven temperature is increased to achieve vaporisation of the reagents in the reagent vials. The selector valve is first opened to the nitrogen gas to purge the capillary. The selector valve is then opened to the first monomer or anchor layer composition (if applicable) for coating the capillary. The selector valve is then opened to the nitrogen gas to flush the capillary, and then opened to the next monomer for coating the capillary, and so on. The oven temperature and/or vacuum pump may be operated to provide varying temperature and pressure conditions for vaporisation of each monomer.

Using the manual apparatus and general process, the inner surfaces of multiple capillary samples were coated with various monomers as exemplified in the following examples.

### Example 1—Anchor Layer Using CVD

The inner surface of four fused silica capillaries were individually coated with an anchor layer using the manual apparatus and general method as described above, with one of the following four alkoxy silanes: trichloro(1H, 1H,2H,2H-perfluorooctyl)silane (PFOCTS), 3-Glycidoxypropyltrimethoxysilane (GPTMS), (3-Aminopropyl)trimethoxysilane (APTMS) and (3-mercaptopropyl)trimethoxysilane (MPTMS). The working conditions used for the alkoxy silane reagents were as follows:

| | Working |
|---|---|
| Reagent | T (° C.) |
| trichloro(1H,1H,2H,2H-perfluorooctyl) silane (PFOCTS) | 25 |
| 3-mercaptopropyltrimethoxysilane (MPTMS) | 50 |
| (3-aminopropyl) trimethoxysilane (APTMS) | 50 |
| (3-glycidyloxypropyl) trimethoxysilane (GPTMS) | 90 |

The electroosmotic flow (EOF) of uncoated and coated capillaries were measured using background electrolytes (BGEs) with equal ionic strengths but at different pH using thiourea as an EOF marker. To demonstrate the uniformity of coating, capillaries were filled with Buffer and the conductivity was measured along the capillaries using C4D before use.

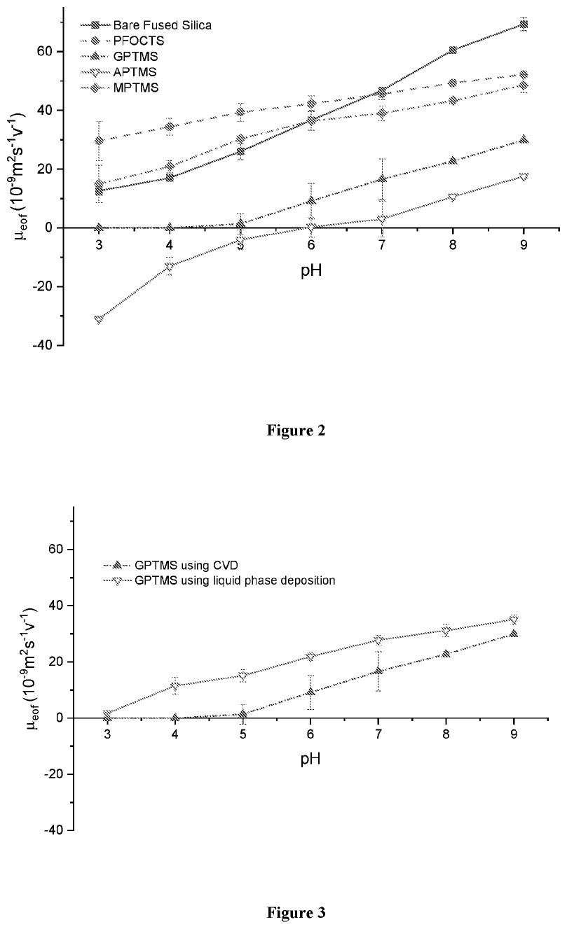

FIG. 2 plots the EOF at different pHs for the internally coated capillaries as compared to an uncoated fused silica capillary. FIG. 2 shows that the uncoated fused silica capillaries have a higher EOF at high pH which decreases with lowering pH. This is due to neutralising of the negative surface charge at lower pH. With the coated capillaries, the methoxy functionalized silanes are bound to the silanol groups on the silica surface changing their surface charge. For both MPTMS and PFOCTS, there was a less pronounced change in EOF with pH relative to APTMS and GPTMS. This is because the MPTMS and PFOCTS monomers are neutral molecules and have reduced the extent of the free silanol groups which contribute to the negative charge on the uncoated capillary internal surface. GPTMS is a neutral molecule with an epoxy group. It binds to the silanol groups lowering the EOF more-so than the uncoated capillaries. APTMS possesses an amino group that gives the molecule a positive charge at lower pH, reversing the EOF of the capillary. None of the coatings fully neutralized the EOF at higher pH due to the residual surface silanol groups that show more effect with increasing pH. This demonstrates that the CVD coating method modified the inner surface of the capillaries to apply an anchor layer.

### Example 2—Anchor Layer Using CVD cf. Liquid Deposition

The efficiency of the traditional liquid-phase coating as compared with the CVD technique of the present invention was compared. Using the traditional method, GPTMS was used in the liquid phase to coat the internal surface of a capillary of internal diameter 25 μm. Using the CVD method and manual apparatus as described above, GPTMS was coated the inner surface of a capillary of internal diameter 25 μm.

The CVD technique showed a higher EOF suppression (as shown in FIG. 3) which demonstrated that a better surface coverage of the inner capillary surface was obtained. The gas-phase CVD coating method is thus demonstrated to be more efficient, in terms of reagent usage, time and EOF suppression, than a liquid-phase process.

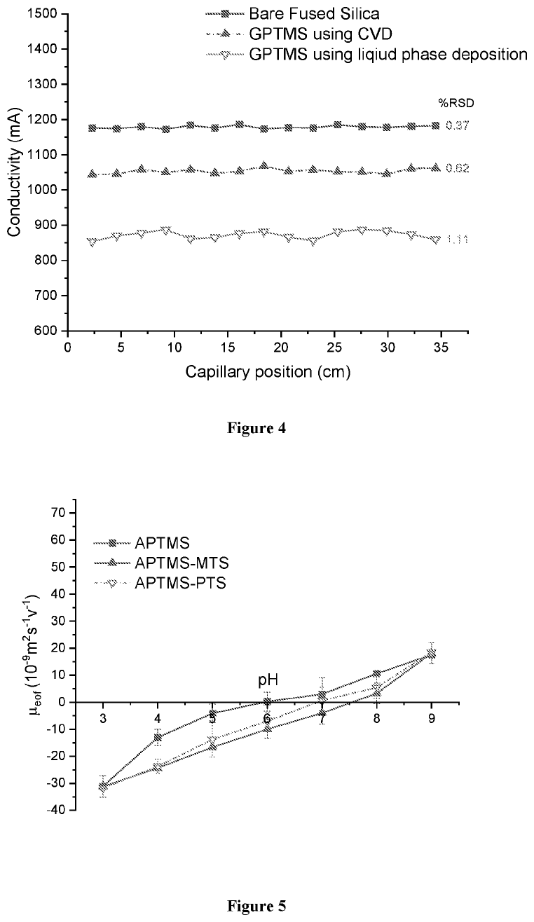

For evaluating the longitudinal homogeneity of the coating, scanning capacitive coupled contactless conductivity was applied in a scanning mode (sC⁴D) before and after each coating layer using a capacitive coupled contactless conductivity detector (C⁴D) (TraceDec) (Innovative Sensor Technologies, Strassahof, Austria). The detector settings for scanning the capillaries were selected as follow: frequency, 2×HIGH; voltage, 0 dB; gain, 200% and offset, 000. For the data acquisition TraceDec Monitor V 0.07a software was used. Capillaries were filled with 9.5 mM Tris/230 mM Citrate, pH 9 buffer using syringe pump adjusted at 1 μL/min flow rate (Harvard Apparatus PHD 2000Programmable Pressure Pump). The capillaries were scanned every 2.5 cm interval, which is the detector head width. If there is fault in the coating and longitudinal homogeneity a high change in the conductivity will appear across the capillaries which will appear as a higher % RSD. However, the coating procedure was homogenous as can be seen in FIG. 4.

### Example 3—Anchor Layer+Capping agent Using CVD

The inner surface of two APTMS-coated capillaries prepared as per Example 1 were individually further coated using the manual apparatus and general method as described above, with an end-capping reagent trichloro methyl silane (MTS) and trichloro phenyl silane (PTS), using the following working conditions:

| Reagent | Working T (° C.) |
|---|---|
| Trichloromethylsilane (MTS) | 25 |
| Trichlorophenylsilane (PTS) | 40 |

The EOF of the APTMS-MTS and APTMS-PTS capillaries was recorded and compared with the APTMS coated capillary (FIG. 5). MTS-treated APTMS-coated capillaries showed a greater decrease in the EOF than PTS-treated APTMS-coated capillaries and an even greater decrease in the EOF than the APTMS-coated capillaries. There was some residual EOF at high pH as shown in FIG. 5, indicating incomplete coverage of the silanol groups of the anchor layer and confirming that there were residual silanol groups of the anchor layer that had not reacted.

### Example 4—Anchor Layer Modification Using CVD

The capability to further modify the inner surface of coated fused silica capillaries via gas-phase chemistry was examined. GPTMS-coated capillaries prepared as per Example 1 were treated with ammonia (NH₃) (of reagent ammonium hydroxide) or sulphuric acid (H₂SO₄) gases using the manual apparatus and general CVD method as described above, and as generally represented in Scheme 1 below, and using the following working conditions:

| Reagent | Working T (° C.) |
|---|---|
| Sulphuric acid | 100 |
| Ammonium hydroxide | 100 |

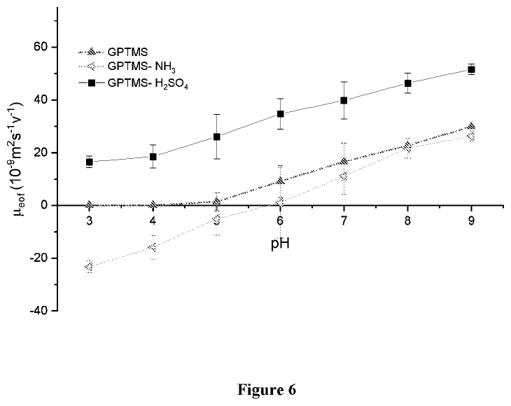

The change in the EOF of the capillaries was measured. Treating the GPTMS with ammonia gas resulted in the epoxy ring being opened to give an amino group, which is evidenced by a reversed EOF (and hence positive surface charge) at a low pH as shown in FIG. 6. H₂SO₄-treated GPTMS-coated capillaries opens the epoxy ring and gives rise to two hydroxyl groups which increased the EOF at higher pH. These two reactions demonstrate the feasibility of performing gas-phase chemical reactions on the inner surface of the capillary to expose functional groups for further coating with monomers, and/or to control the magnitude and type of surface charge.

### Example 5—Anchor Layer+Step-Wise Polymerisation Using CVD+MLD

The capability to perform subsequent gas-phase monomer coating of the inner surface of coated fused silica capillaries was examined. Using and manual apparatus and general CVD method as described above, gas-phase polymerization was performed in which a GPTMS-coated capillary prepared as per example 1 was ring-opened with p-phenylenediamine to give an aminated surface, and the free amino group was further reacted with terephthalaldehyde to give an aldehyde group. The aldehyde was then reacted with the p-phenylenediamine in subsequent MLD coating steps to form a Kevlar polymer as generally represented in Scheme 1.

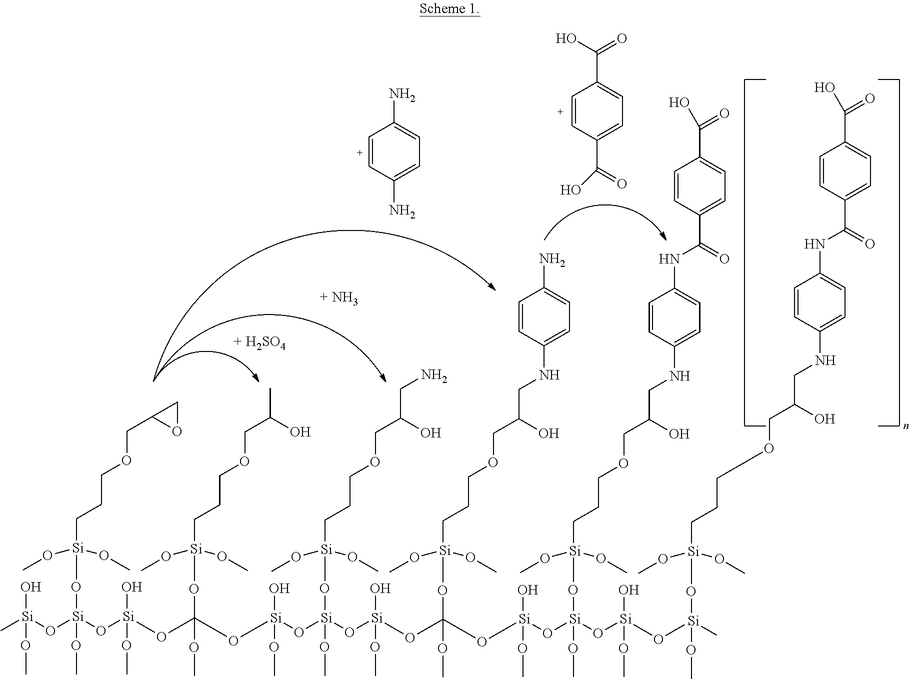

The working conditions used were as follows:

| Reagent | Working T (° C.) |
|---|---|
| Terephthalaldehyde (TA) | 120 |
| p-Phenylenediamine (PD) | 150 |

The details of the method used are set out as follows:
a) Applying anchor layer:
   One end of the capillary is attached to the vacuum pump, the other end to an arm of a T-piece tube connector. The other arms of the T-piece were connected to a nitrogen gas inlet and the reagent vial containing 30 μl GPTMS. The capillary and reagent vial was inserted into an oven.
   Vacuum was applied to the capillary for 10 minutes at room temperature before the oven was operated and the temperature was increased to 90° C. and held.
   After 12 hours, a valve to the nitrogen gas source is opened and nitrogen gas is applied to the inside of the capillary under vacuum for 10 minutes to purge the capillary. The temperature is then dropped to 25° C.
b) Applying second layer (anchor layer+one monomer):
   A clean reagent vial was filled with the reagent p-phenylenediamine (PD) and connected to the capillary with nitrogen source as above.
   Vacuum was applied to the capillary for 10 minutes at room temperature before the oven was operated and the temperature was increased to 120° C. and held.
   After 12 hours, a valve to the nitrogen gas source is opened and nitrogen gas is applied to the inside of the capillary under vacuum for 10 minutes to purge the capillary. The temperature is then dropped to 25° C.
c) Applying third layer (anchor layer+two monomers)
   A clean reagent vial was filled with the reagent terephthalaldehyde (TA) and connected to the capillary with nitrogen source as above.
   Vacuum was applied to the capillary for 10 minutes at room temperature before the oven was operated and the temperature was increased to 150° C. and held.
   After 12 hours, a valve to the nitrogen gas source is opened and nitrogen gas is applied to the inside of the capillary under vacuum for 10 minutes to purge the capillary. The temperature is then dropped to 25° C.
d) Applying a fourth layer (anchor layer+three monomers)
   Repeat step b).
e) Applying a fifth layer (anchor layer+four monomers)
   Repeat step c).

Steps b) and c) are then repeatable to grow the polymer to the desired extent.

For evaluating the effect of the coating layers on the silica surface charge, an Agilent 7100 CE (Agilent Technologies, Waldbronn, Germany) was used to measure EOF of capillaries at different pH. Capillaries (Polymicro Technologies, Phoenix, AZ, USA) with a 25 μm internal diameter and a total length of 32 cm, 23.5 cm to a UV detector, set at 210 nm and thermostated at 25° C. were used. The coated capillaries were flushed before each run with the BGE for 5 minutes by applying a pressure of 4 bar. Separation was performed using normal polarity and reversed polarity using ±30 kV according to the EOF direction. The BGEs were composed of Tris HCl and citric acid at different molar concentration in Milli-Q water (Millipore, Bedford, MA, USA) to cover the pH range from 3 to 9 while keeping the ionic strength constant over the pH range. 10 ppm thiourea dissolved in water, as a neutral EOF marker, was injected by applying 50 mbar for 5 seconds. All solutions were filtered through a 0.2 μm Millipore filter. The concentrations of citric acid and tris HCl having the same ionic strength at different pH, used for EOF measurements and sC⁴D, are shown in Table 2.

TABLE 2
Concentrations of citric acid and tris HCl having the same ionic
strength at different pH, used for EOF measurements and sC⁴D.

| pH | Citric Acid (mM) | Tris HCL (mM) | Ionic Strength (mM) |
|---|---|---|---|
| 3 | 110 | 55 | 57.879 |
| 4 | 40 | 48 | 58.783 |
| 5 | 20 | 38 | 57.836 |
| 6 | 12.5 | 32 | 57.868 |
| 7 | 10 | 31.5 | 57.669 |
| 8 | 9.5 | 48 | 56.732 |
| 9 | 9.5 | 230 | 56.986 |

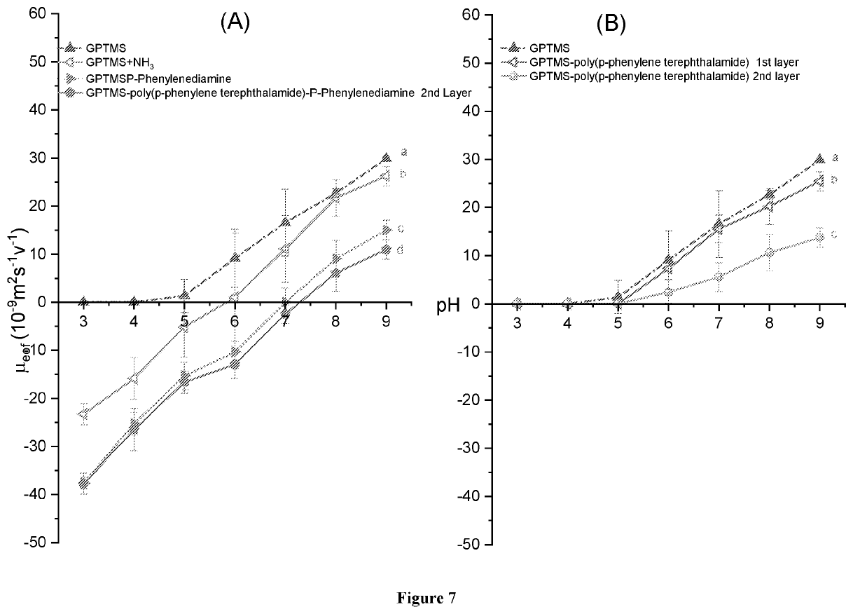

The EOF was measured after the deposition of each layer at different pH values to see the effect on reducing EOF and shielding the residual silanol groups. As shown in FIG. 7(A), after opening the epoxy ring with PD the surface became positively charged and a reversed anodic EOF was obtained at lower pH, which was even lower than the one treated with ammonia. Adding another layer of TA, then treating with PD again, showed a greater decrease in the EOF especially at high pH. This is where the residual silanol groups have higher effect and indicates that the polymer formation has reduced the effect of the residual silanol groups. This is seen in FIG. 7(B), but with the neutral aldehydic surface. Each layer of TA give rise to a lower EOF indicating further blockage and shielding of the silanol groups. The PPTA coated capillaries exhibited a pH independent EOF. This also showed that the longitudinal growth of the coating is lowers the EOF and increases the shielding of the residual silanol groups.

While exemplified here is a GPTMS anchor layer followed by step-wise polymer growth with alternating treatments of PD then TA, equally applicable is an anchor layer of APTMS and, using the same method, step-wise polymer growth with alternating treatments of TA and PD. Also equally applicable are embodiments using the acyl chloride (terephthaloyl chloride—TC) in place of terephthaldehyde; that is, an anchor layer of GPTMS or APTMS and, using the same method, step-wise polymer growth with alternating treatments of TC and PD or PD and TC, as generally represented in Scheme 2.

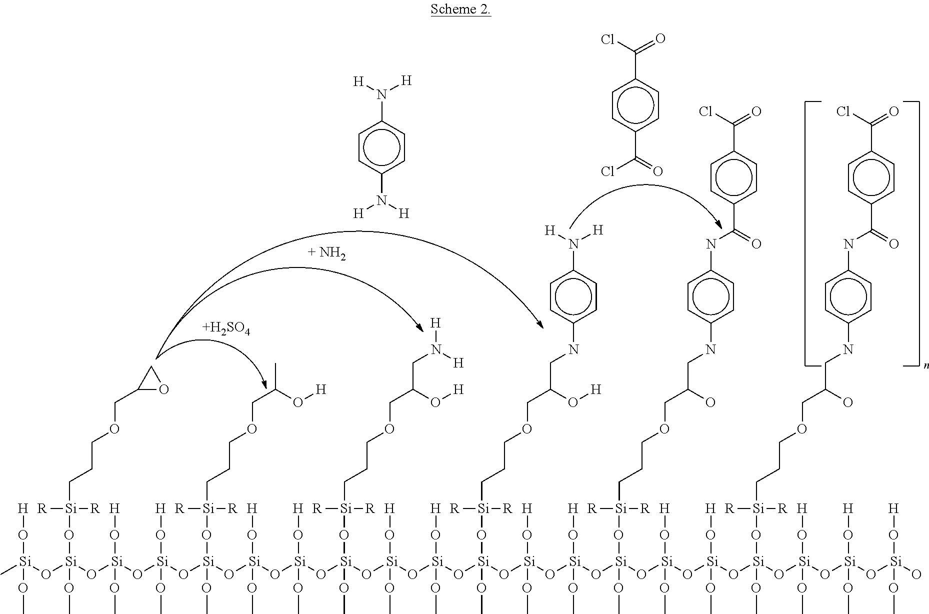

### Example 6—Anchor Layer Stability

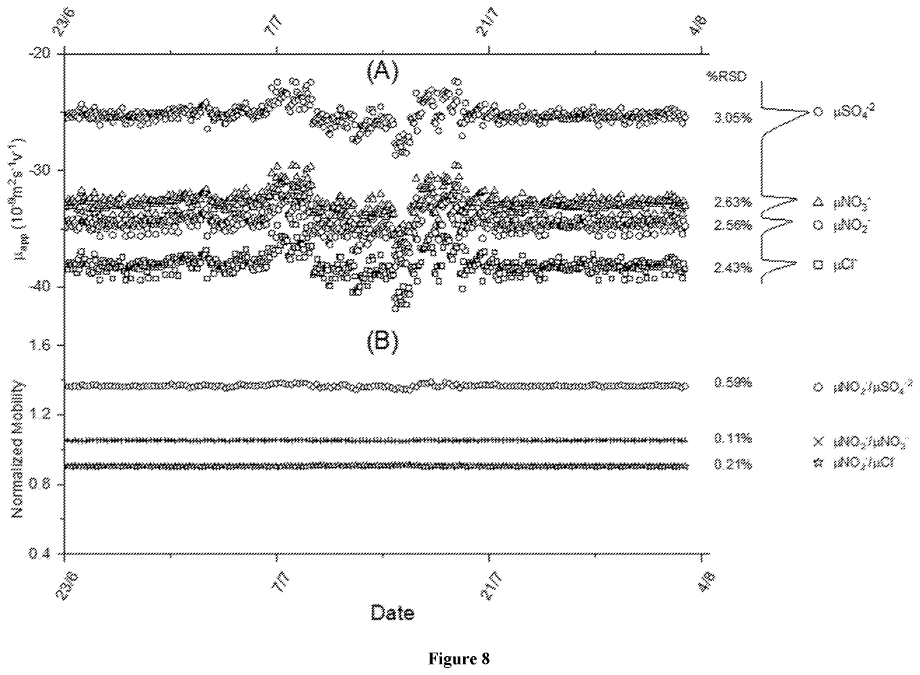

To test the stability of the coating, for example for applications of capillary electrophoresis, the separation of chloride, nitrate and sulfate anions in water were monitored for more than 1 month (35 days) using a GPTMS-coated capillary. As shown in FIG. 8(A) the capillary showed less than 17.51% RSD in the mobility of these ions, and as shown in FIG. 8(B), less than 3.76% when nitrite used as an internal standard. This demonstrates the permanent stability of this and other coatings applied using the method (i.e. covalently bonded), and that the coating is not simply a physical adsorption of the reagents onto the inner surface of the capillary.

### Example 7—Capillary Electrophoresis

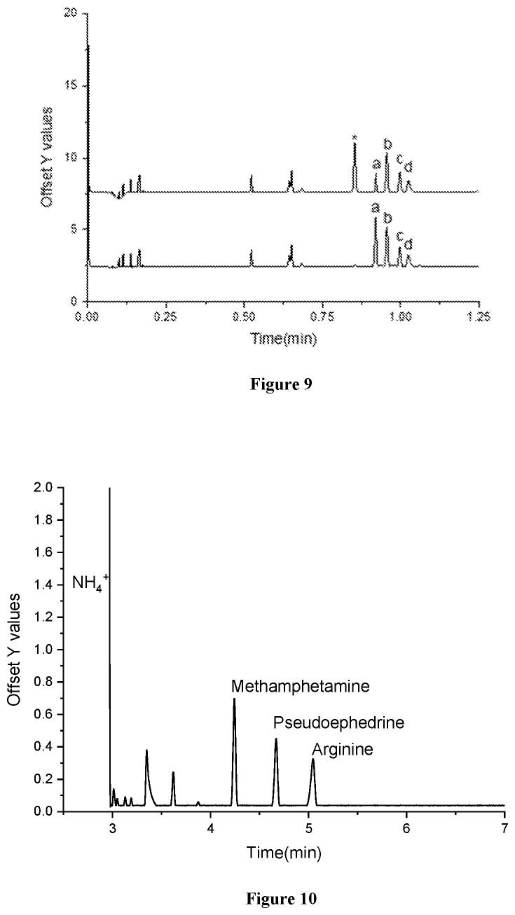

Capillaries coated with GPTMS prepared as per Example 1 were used to separate pharmaceutical products epinephrine, lidocaine, bupavacaine and dubutamine from degradation product of epinephrine, obtained from metal coupons obtained using a swab-based technique from their degradation product. This is shown in FIG. 9.

### Example 8—Capillary Electrophoresis

GPTMS-coated capillaries were used to detect methamphetamine and its precursors pseudoephedrine and arginine, from samples obtained using a swab-based technique but with the addition of a transient isotachophoresis (tITP) step to improve the sensitivity, as shown in FIG. 10. This has various application in drug detections including in applications to identify buildings that have been used as clandestine laboratories.

### Example 9—Anchor Layer+Step-Wise Polymerisation Using CVD+MLD

Using the automated apparatus and general process, the inner surfaces of multiple capillary samples were coated with monomers as exemplified in the following.

Gas-phase polymerization was performed in which a GPTMS-coated capillary prepared as per example 1 was ring-opened with p-phenylenediamine to give an aminated surface, and the free amino group was further reacted with terephthalaldehyde to give an aldehyde group. The aldehyde was then reacted with the p-phenylenediamine in subsequent MLD coating steps to form a Kevlar polymer as generally represented in Scheme 1 having up to 50 layers of the PD-TA unit, being up to 100 individually applied monomer layers, terminated in one set with p-phenylenediamine and in another with terephthalaldehyde. Reagents, working conditions and coating steps were similar as those specified in Example 5, except using the automated apparatus and general process.

For evaluating the effect of the coating layers on the silica surface charge, an Agilent 7100 CE (Agilent Technologies, Waldbronn, Germany) was used to measure EOF of capillaries at different pH. Capillaries (Polymicro Technologies, Phoenix, AZ, USA) with a 25 μm internal diameter and a total length of 32 cm, 23.5 cm to a UV detector, set at 210 nm and thermostated at 25° C. were used. The coated capillaries were flushed before each run with the BGE for 5 minutes by applying a pressure of 4 bar. Separation was performed using normal polarity and reversed polarity using ±30 kV according to the EOF direction. The BGEs were composed of Tris HCl and citric acid at different molar concentration in Milli-Q water (Millipore, Bedford, MA, USA) to cover the pH range from 3 to 9 while keeping the ionic strength constant over the pH range. 10 ppm thiourea dissolved in water, as a neutral EOF marker, was injected by applying 50 mbar for 5 seconds. All solutions were filtered through a 0.2 μm Millipore filter. The EOF was measured after the deposition of 1, 2, 5, 10, 25 and 50 layers of the PD-TA unit, being up to 100 individually applied monomer layers at different pH values to see the effect on reducing EOF and shielding the residual silanol groups.

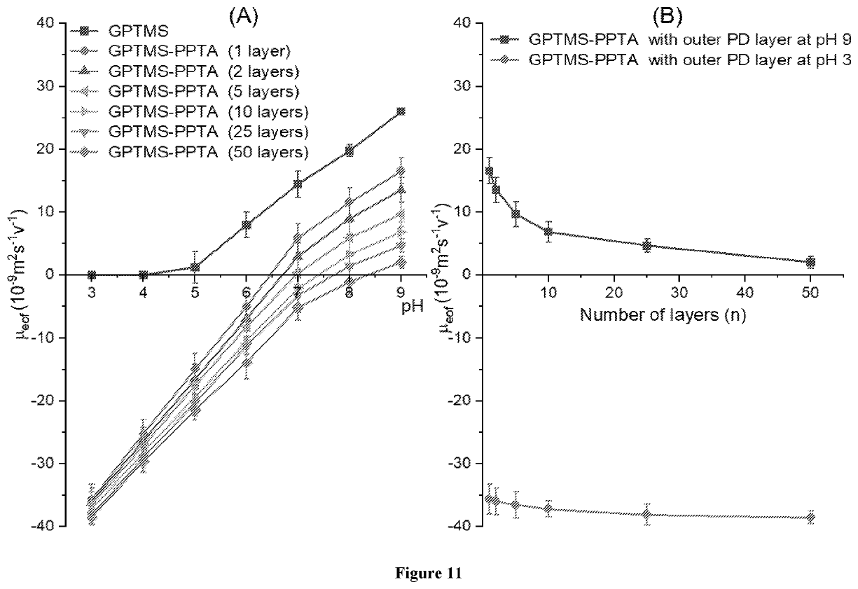

As shown in FIG. 11(A), which relates to the capillary set terminated with p-phenylenediamine, the greater the number of layers the greater decrease in the EOF especially at high pH indicating that the polymer formation has reduced the effect of the residual silanol groups. This is represented in FIG. 11(B) which shows the influence of adding (n) number of layers measured at pH 3 and 9.

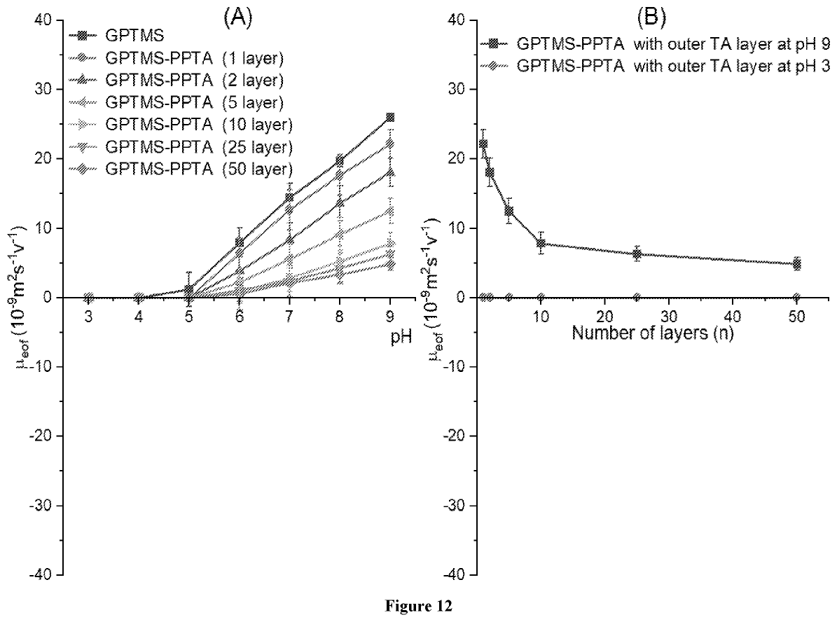

As shown in FIG. 12(A), which relates to the capillary set terminated with terephthalaldehyde, the greater the number of layers the greater decrease in the EOF especially at high pH indicating that the polymer formation has reduced the effect of the residual silanol groups. This is represented in FIG. 12(B) which shows the influence of adding (n) number of layers measured at pH 3 and 9.

The above examples are only the preferred examples of the present disclosure. It shall be pointed out that various improvements and modifications could be made by those ordinarily skilled in the art without deviating from the principle of the present disclosure, which shall fall within the protection scope of the present disclosure.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein, except where the context requires otherwise due to express language or necessary implication, the articles “a” and “an” are used herein to refer to one or to more than one (i.e. to at least one) of the grammatical object of the article. By way of example, “an element” means one element or more than one element.

1-33. (canceled)

34. A method for the production of an inner surface coating on an enclosed article, the method comprising vaporizing a first monomer and reacting the vaporized first monomer with the inner surface of an enclosed article to provide a first monomer layer on the inner surface of the enclosed article.

35. The method according to claim 34, further comprising vaporizing a second monomer and reacting the vaporized second monomer with the first monomer on the inner surface of the enclosed article to provide a second monomer layer on the inner surface of the enclosed article.

36. The method according to claim 35, further comprising individually vaporizing one or more subsequent monomers and separately reacting each vaporized monomer with the previous monomer on the inner surface of the enclosed article to form an oligomeric or polymeric layer on the inner surface of the enclosed article.

37. The method according to claim 35, further comprising:
repeating the step of vaporizing the first monomer and reacting the vaporized first monomer with the inner surface of the enclosed article, where the inner surface comprises the second monomer layer; and
repeating the step of vaporizing a second monomer layer and reacting the vaporized second monomer layer with the first monomer on the inner surface of the enclosed article;
in alternating steps to form an oligomeric or polymeric layer on the inner surface of the enclosed article.

38. The method according to claim 35, wherein the second monomer is selected from the group consisting of 4,4′-diaminodiphenyl ether or 4,4′-oxydianilie, 2,4-diaminonitrobenzene, p-phenylenediamine, ethylene diamine, 1,6-hexenediamine, oxalic dihydrazide, 2,2′thiobisethylamine, 2,2′(propane-2,2-diylbis(oxy)) diethanamine, diethylenetriamine, triethylenetetramine, tris(2-aminoethyl)amine, adipoyl chloride, terephthaloyl chloride, terephthalaldehyde, 1,4-phenylene diisothiocyanate, 1,2-ethanedithiol, 1,4-butanedithiol, 1,10-decanedithiol, 1,4-benzenedimethanethiol, 1,4-benzenedithiol and 1,10-decanedithiol.

39. The method according to claim 34, wherein the first monomer is selected form the group consisting of pyromellitic dianhydride, terephthalaldehyde, 1,4-phenylene diisocyanate, 1,4-diisocyanatobutane, 1,6-hexanediamine, p-phenylenediamine, 1,4-butanediamne, ethylenediamine, ethylene glycol, 1,7-octodiene and 1,11-dodecadiene.

40. The method according to claim 34, wherein the vaporization and reaction step is performed:
under a negative pressure; and/or
at a temperature of at most 180° C.

41. The method according to claim 35, wherein after the or each vaporization and reaction step, the method comprises flushing the enclosed article with an inert gas.

42. The method according to claim 34, wherein the method comprises:
a preliminary step of vaporizing an anchor layer composition and reacting the vaporized anchor layer composition with a native inner surface of the enclosed article to provide an anchor layer on the inner surface of the enclosed article; and
optionally a subsequent preliminary step of treating the inner surface with a capping reagent.

43. The method according to claim 42, wherein:
a native inner surface of the enclosed article is fused silica;
the anchor layer composition is a silane selected from the group consisting of 3-Glycidoxypropyltrimethoxysilane, (3-Aminopropyl)trimethoxysilane and (3-mercaptopropyl)trimethoxysilane; and
the subsequent preliminary step of treating the inner surface with a capping reagent is performed, and the capping reagent is selected from trichloromethylsilane and trichlorophenylsilane.

44. The method according to claim 43, wherein the preliminary steps are performed:
under a negative pressure; and/or
at a temperature of at most 180° C.

45. The method according to claim 34, wherein the enclosed article is a capillary.

46. A coated capillary, the capillary comprising a polymeric inner surface coating with a uniform, controlled polymer chain length.

47. The capillary according to claim 46, wherein the polymer is an alternating copolymer comprising first and second monomers.

48. The capillary according to claim 47, wherein:
the first monomer is selected form the group consisting of pyromellitic dianhydride, terephthalaldehyde, 1,4-phenylene diisocyanate, 1,4-diisocyanatobutane, 1,6-hexanediamine, p-phenylenediamine, 1,4-butanediamne, ethylenediamine, ethylene glycol, 1,7-octodiene and 1,11-dodecadiene; and
the second monomer is selected from the group consisting of 4,4′-diaminodiphenyl ether or 4,4′-oxydianilie, 2,4-diaminonitrobenzene, p-phenylenediamine, ethylene diamine, 1,6-hexenediamine, oxalic dihydrazide, 2,2′thiobisethylamine, 2,2′(propane-2,2-diylbis(oxy)) diethanamine, diethylenetriamine, triethylenetetramine, tris(2-aminoethyl)amine, adipoyl chloride, terephthaloyl chloride, terephthalaldehyde, 1,4-phenylene diisothiocyanate, 1,2-ethanedithiol, 1,4-butanedithiol, 1,10-decanedithiol, 1,4-benzenedimethanethiol, 1,4-benzenedithiol and 1,10-decanedithiol.

49. An apparatus for forming an inner surface coating on an enclosed article, the apparatus comprising:
a heating chamber
a reagent vessel
connectors for fluid connection of the enclosed article with the reagent vessel and a vacuum pump so that the enclosed article will be positioned within the heating chamber and in fluid connection with the regent vessel and a vacuum pump when connected;
whereby, in operation, a reagent can be vaporized in the reagent vessel under vacuum and/or upon the application of heat, and the vaporized reagent can pass into the enclosed article for reaction with the inner surface of the enclosed article for the formation of a coating of the inner surface of the enclosed article.

50. The apparatus according to claim 49, wherein the connectors are configured to avoid an outer surface of the enclosed article being exposed to vapourized reagent.

51. The apparatus according to claim 49, further comprising:
a condenser positioned externally to the heating chamber and upstream of any connected vacuum pump; and/or
a vacuum pump positioned externally to the heating chamber and down-stream of any condenser.

52. The apparatus according to claim 49, further comprising a valve for controlling vaporized reagent flow into the enclosed article.

53. The apparatus according to claim 49, comprising a connector for connecting an inert gas source in fluid connection with the enclosed article, and an inert gas source, wherein the connection of the inert gas source is optionally made via a valve for controlling the inert gas flow into the enclosed article, wherein the valve is the same or different to any valve for controlling vaporized reagent flow into the enclosed article.
